(19) United States
(12) Patent Application Publication
(10) Pub. No.: US 2011/0231361 A1
(43) Pub. Date: Sep. 22, 2011

(54) CONSOLIDATED SECURITY APPLICATION DASHBOARD

(75) Inventors: Phanikumar PATCHAVA, Bangalore (IN); Vineeth NARASIMHAN, Bangalore (IN); Sandeep SINGHAL, Bangalore (IN); Marc William SOLOMON, Bethesda, MD (US); Walter James CLARK, Hulmeville, PA (US)

(73) Assignee: FIBERLINK COMMUNICATIONS CORPORATION, Blue Bell, PA (US)

(21) Appl. No.: 12/983,089

(22) Filed: Dec. 31, 2010

Related U.S. Application Data
(60) Provisional application No. 61/291,468, filed on Dec. 31, 2009.

(51) Int. Cl. G06F 17/30

(52) U.S. Cl. 707/602; 707/E17.044

(57) ABSTRACT

A consolidated security application dashboard system is described wherein a plurality of endpoint systems include visibility agents that collect status and event attributes/metrics from a plurality of security applications and upload the information to datamarts on a backend server. The backend server aggregates and processed the security application attributes/metrics to enable configurable dashboards to present summary and detailed information to IT users about the security metrics relating to a group of endpoints.

### CROSS-REFERENCE TO RELATED APPLICATIONS

This application claims priority to U.S. provisional application Ser. No. 61/291,468 filed Dec. 31, 2009, which is incorporated herein by reference in its entirety.

### TECHNOLOGY FIELD

The present invention relates generally to the management of computer-based information systems, and more particularly to systems and methods that enable a unified and centralized view of various security applications deployed in a customer environment.

### BACKGROUND

The industrialized world is becoming increasingly dependent on computing devices, such as computers and smart mobile devices, including mobile phones, connected via a network. Advances in the global computing and telecommunication infrastructure have provided significant flexibility in corporate operations and in the way organizations view their workforce. For example, increasing numbers of employees work from remote locations (e.g., home, hotel, airport, etc.) by accessing corporate resources via a secure connection to their employer's computer network. Also, the number and types of communications mediums available for making a connection are also increasing and providing users with multiple means for connecting to a network.

Additionally, users can access network resources from a variety of disparate network and computer resources. The variety of computing environments used by users or customers to access network resources can make managing security and access difficult for IT managers. There is a need to make collecting, accessing, aggregating, analyzing, and managing information about user computing environments simpler and more ubiquitous to allow IT managers to respond to trends, threats, user needs.

Conventional management tools provide no visibility into laptops, distributed PCs and mobile devices when these are beyond the corporate firewall and not connected to the corporate network. This creates a “Mobile Blind Spot” which increases as more employees work at home and in the field, use public email services, and utilize web-based business applications.

In addition, most IT groups use a patchwork of management and security tools to support mobile workers. This results in inefficiencies, duplication of effort, and time-consuming manual workarounds. And unless mobile devices are kept fully up to date, the data on them is vulnerable to zero-day viruses, hackers and the loss or theft of the devices.

So while more workers are enjoying the productivity gains that come with mobility, IT organizations are faced with rising management and support costs, increasing risks of security breaches, and an overall lack of visibility and control related to mobile and distributed endpoints.

For example, users may have security applications from multiple vendors in their environment. To get information about each of these applications the user or IT manager might need to access multiple consoles, applications, or have direct access to the client machine. This can be a time consuming process. In such a scenario, information analysis is difficult and decision making imperfect.

There has been some effort in the prior art towards standardizing on a particular Application Suite that includes multiple security applications like anti-virus, personal firewall, anti-spyware, encryption and backup and recovery bundled together to enable easy management and reporting. For example, one popular product, Symantec Endpoint Protection, from Symantec enables IT Administrators to gather some information whether Anti-Virus is installed or not, Anti-Virus Status, Last Definition Date, Last Full Scan Date, whether Anti-Spyware is installed or not, etc., about the deployed base. However, this information tends to be limited to identifying the state of single-branded (e.g. Symantec) software packages on the client machines and fails to provide a complete view of the environment of network users. A further limitation to these prior art attempts is that they require that the endpoint be either within the corporate network or connected via VPN and hosted within the corporate environment to provide information. Furthermore, because the analysis is limited to special software on the client computer, there remains a need for an extensible, customizable method for gathering and analyzing environmental conditions, including those related to software from multiple vendors and operating systems.

These problems become acute in case of a merger and acquisition as the target company may have completely different applications deployed and IT Administrators struggle for considerable periods of time to get a unified view across all their devices.

IT administrators desire access to data that can be used to understand user behavior and experience. Information derived from this data may be compelling and valuable to a company. A problem currently evolving is that the market is moving toward a user empowered selection of connection, software, environmental configurations and the like, which creates a reporting gap. This is a mechanism to maintain and enhance the value provided in the collection and reporting of endpoint environmental configurations.

### SUMMARY

Embodiments of the present invention address and overcome one or more of the above shortcomings and drawbacks, by providing devices, systems, and methods for unified status reporting of various security applications. This technology is particularly well-suited for, but by no means limited to, security applications.

The present invention is geared towards addressing these specific problems of IT Administrators and Security Manager by enabling them with a unified and centralized view of various security applications deployed in the customer environment. The present invention provides a dashboard that enables IT/security manages to view and analyze key application status information for a range of different security application types—Anti-Virus, Personal Firewall, Anti-Spyware, Zero Day Threat Protection, Encryption, Backup & Recovery, Data Leak Prevention, Peripheral Protection, OS Patching and important Windows Application Updates, or other OS specific updates.

One aspect of the present invention provides a dashboard system that includes vendor-agnostic collection, access, aggregation, analysis, and management of environmental status information and works with a wide array of security application vendors. One aspect of the present invention provides a dashboard system the can be easily updated to support the latest security product releases from existing and new vendors and new product launches. In this regard, the dashboard system is extensible and customizable. Its capabilities can be upgraded as new threats are identified and as new solutions or other software become available for endpoint systems. In one aspect of the present invention the dashboard system the extensibility includes the ability to define new application types (e.g. software that enables protection from a new class of threat, or other types of software not contemplated by the IT manager at initial deployment of the dashboard system) when a new genre of applications gain acceptance in the market.

One aspect of the present invention provides a method aggregating data from computing devices on networks. The system receives, over a network, environmental status information pertaining to each of a first subset of a plurality of endpoints located on one or more networks. The system stores the environmental status information in a first group-specific data store assigned to the first subset of endpoints. The system then sorts the environmental status information into one or more predetermined data stores based on the type of environmental status information received, and normalizes the environmental status information to create normalized environmental status information. The normalized environmental status information is then stored in a consolidated datamart.

In some embodiments, the system receives environmental status information pertaining to another subset of endpoints and stores the information in a second group-specific data store. The environmental status information may include information pertaining to more than one application type or platform type, such that the first environmental status is sorted into multiple data stores. In some embodiments, the system sorts the environmental status information by identifying an application running on the subset of endpoints, or the platform type of the endpoint, to which the environmental status information relates.

In some embodiments, the system receives environmental status information from one or more agents operating on at least a portion of the first subset of a plurality of endpoints or servers that communicates with at least a portion of the endpoints. These endpoints can be on separate VPNs.

In some embodiments, the system displays one or more summaries of the normalized environmental status information. By normalizing the environmental status information, including mapping values received to uniform values, entries in the consolidated datamart can be uniformly displayed regardless of vendor information.

One aspect of the present invention provides a system for aggregating data from computing devices on networks. The system includes a computer configured to receive, over a network, environmental status information pertaining to a plurality of endpoints located on one or more networks. A first datamart includes a plurality of group-specific data stores, which are assignable to subsets of endpoints. A first group of application specific staging marts includes storage and logic that normalizes the environmental status information to create normalized environmental status information. Logic sorts the first environmental status information into one or more application specific staging marts based on the type of environmental status information received. A second datamart contains consolidated environmental status data received from the first group of application specific data marts. In some embodiments, the system further includes a web interface that allows displaying one or more summaries of the normalized environmental status information.

Additional features and advantages of the invention will be made apparent from the following detailed description of illustrative embodiments that proceed with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a block diagram of an exemplary embodiment of computer system for use in accordance with the embodiments of the invention;

FIG. 2 is a block diagram of a consolidated security application in accordance with certain embodiments of the invention;

FIG. 3 is a top level data flow of the operation of certain embodiments of the invention;

FIG. 4 is a data flow showing the operation of visibility agents in accordance with certain embodiments of the invention;

FIG. 5 is a data flow showing the operation of a backend server in accordance with certain embodiments of the invention;

FIG. 6 is a data flow showing the operation of data cleansing logic in accordance with certain embodiments of the invention;

FIG. 7 is a data flow showing the operation of data consolidation logic in accordance with certain embodiments of the invention;

FIGS. 8A and 8B are a data flow showing the method to update certain data structures to support new version of security applications in accordance with certain embodiments of the invention;

FIG. 9 is a data flow showing the method to support new dashboards in accordance with certain embodiments of the invention;

FIGS. 10A-15 are exemplary screenshots of exemplary dashboards in accordance with certain embodiments of the invention;

FIG. 16 is a diagram of a sample data structure for use in accordance with certain embodiments of the invention;

FIGS. 17-18 are screenshots of exemplary dashboards in accordance with certain embodiments of the invention;

FIG. 19A-B are diagrams of a sample data structure for use in accordance with certain embodiments of the invention; and

FIGS. 20-21 are screenshots of exemplary dashboards in accordance with certain embodiments of the invention.

### DETAILED DESCRIPTION OF ILLUSTRATIVE EMBODIMENTS

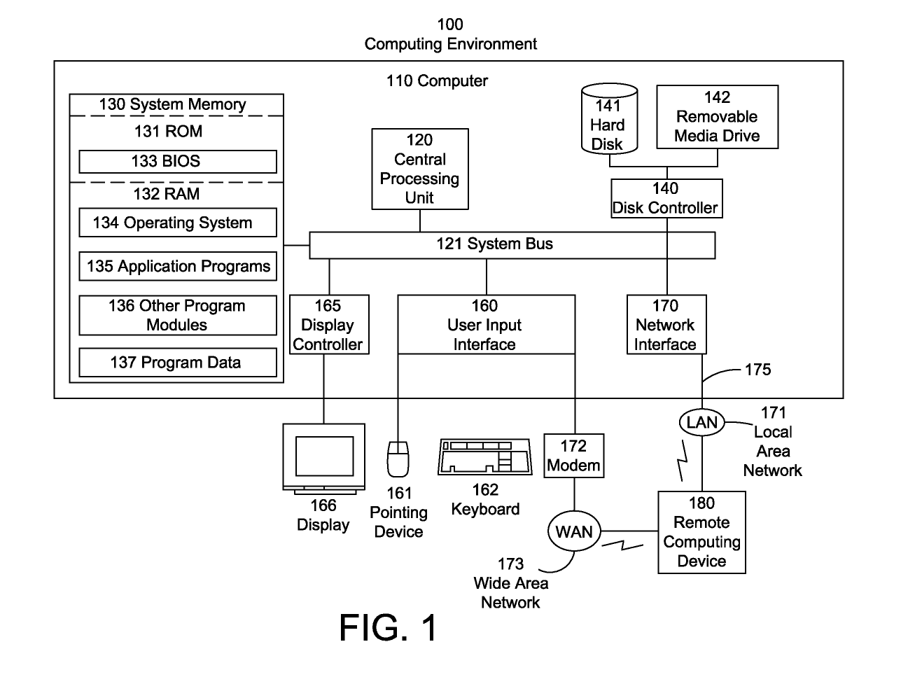

The present invention includes a Dashboard system for use with a client server environment using conventional computing systems. An example of a computing system is shown in FIG. 1. The system further includes endpoint systems that can include, for example, a laptop, desktop, mobile device, such as a mobile phone, or other device suitable for a user to access network resources. The endpoint systems are capable of acting as a client for the dashboard system by running a script, application, program, or operating system extension that is capable of gathering and reporting environmental status information to a server that is capable of collecting client-side data for use with a dashboard. The backend server can include one or several central-oriented computers that may be, for example, in a load balancing, or hierarchical configuration. The server computers can include any combination of conventional server computers, such as a network-attached computer having an operating system. The backend server can be located on or off-site to the local network to which endpoints are attached.

The Dashboard system is suitable for collection, access, aggregation, analysis, and management of environmental status information from a plurality of endpoint computers. The dashboard system includes two main components: 1) a visibility agent module that resides on the endpoint systems, or hosts in communication with the endpoint and having access to endpoint configuration information, that is responsible for collecting information about various security applications on the endpoint and peripheral devices connected to the endpoint; and 2) a set of backend applications on the server(s) that include datamarts that stores Application data and a set of Dashboards. A datamart can include a subset of an organizational data store, usually oriented to a specific purpose or major data subject, and may be distributed to support business needs. A datamart can include a subset of a datamart or an entire datamart. A plurality of endpoint systems each include an instance of the visibility agent module. In some embodiments, the server can gather data directly from certain security applications that interact with the server's backend consoles from some or all of the endpoint systems.

Visibility Agent Module

The Visibility agent module is a client-side application or software module that acts as an agent for gathering and uploading information about the environment of the endpoint, and thus providing visibility about the environment of the endpoint. In some embodiments, the visibility agent module has a flexible scripting engine that runs a series of scripts deployed. Embodiments of the visibility agent module can include an application, a module within an application, an -applet, a plug in, or part of an operating system or kernel. The scripts executed by the visibility agent module collect environmental status information, which can include status of security software, patches, vulnerabilities, updates, hardware and software inventory, software usage information as well as time based incident information like viruses/malwares found, device attacks, data leak incidents, OS events, and the like, as well as any of the other status information described throughout this application.

An embodiment of a visibility agent could also be a native operating system process or API that presents certain endpoint configuration information. For example, some mobile operating systems, such as iOS4 include a native API, such as the Mobile Development Management API, that expose certain system attributes that can be collected in accordance with the methods discussed herein.

The scripts can gather this status information by interacting with external security application status reporting SDKs like Opswat (www.opswat.com) or individual security applications via APIs or can further leverage OS level attributes to capture the required information about security applications on the device. These SDKs can be installed on the endpoint and can with software like the visibility agent. The SDK queries for security metrics from various security applications and return it to the visibility agent.

The flexible scripts framework gives the solution the ability to upgrade the same to collect information for newer products/vendors as well as additional information for particular Application Type by modifying existing scripts or deploying new scripts adapted to collect new desired information.

The visibility agent module also has the ability to upload the collected data. The data can be uploaded as per pre-defined interfaces, such as interfaces that are defined for a particular application type. For example, information gathered by a visibility agent relating to anti-virus software can have a common upload interface for all information relating to the Application Type of antivirus software, irrespective of the specific antivirus application installed and from which the information is gathered.

The visibility agent module can collect attributes that are common for all types of security applications and application type-specific attributes. The attributes collects by the visibility agent can be referred to as attributes or metrics depending on their usage, where metrics can be a raw attribute, a calculated value or other value relating to or derived from an attribute, or a subset of attribute information. Examples of generic attributes common to all Security Application Types can include: application name; application type; vendor; application version; installed date; application status. Examples of application type-specific attributes that can be collected in certain embodiments include the following for anti-virus and anti-spyware: application definition date; application definition version; last scan date, or any other attribute that may be desirable for inclusion in a dashboard. In some embodiments, the visibility agent detects the presence of encrypted drives. In some embodiments, various device attributes such as computer name, OS username can also be collected which are combined with the above captured application attributes.

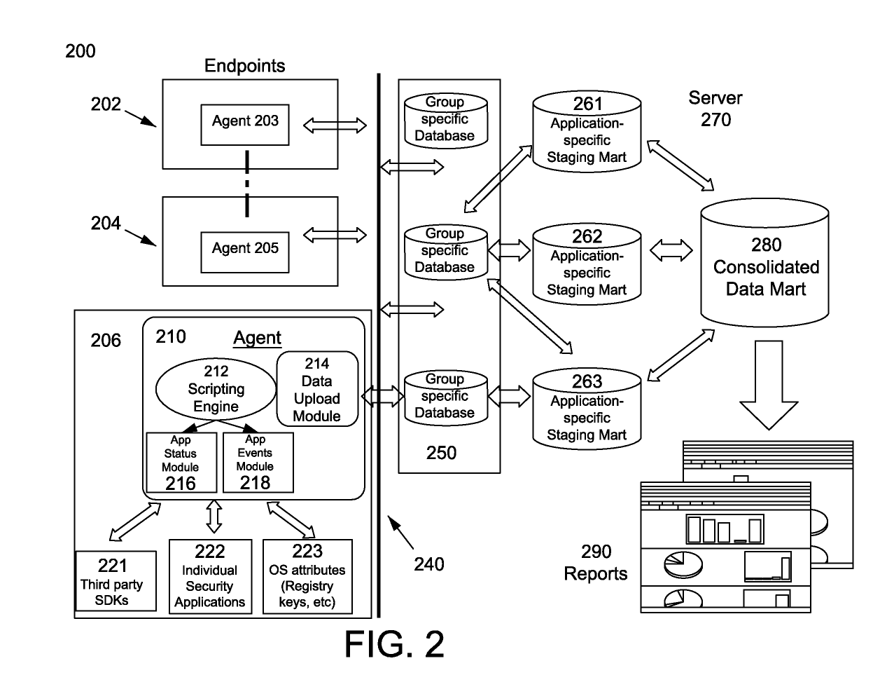

Referring to FIG. 2, a plurality of endpoints 202, 204, and 206 each include an instance of a visibility agent 203, 205, and 210 for gathering local environment information. In at least one embodiment, a visibility agent 210 includes a scripting engine 212 for executing scripts to gather desired environmental information, including obtaining, obtaining, creating, pre-processing, and preparing the information for sending to the server 270.

In some embodiments, visibility agent 210 can reside on endpoint 206. Visibility agents can also be included in a server on the client-side of networks 240, such as integrated into an Exchange server that communicates with endpoints, such as 202 and 204. For instance, an Exchange server in communication with an endpoint, such as a mobile device, for sending, receiving, and syncing personal data, such as email and calendar, collects status information about the endpoint during this communication when using an active sync protocol. This can allow visibility agents to collect information about a device that communicates with the server, without adding to the complexity of software operating on the endpoint. Another example includes a visibility agent operating as part of a Blackberry Enterprise Server, which has access to many attributes and status information (e.g. home carrier, current carrier, signal strength, GPS location, onboard memory, OS version, softwareinstalled) of handheld mobile devices syncing with the server. Advantages of a visibility agent operating on a server or gateway that syncs with, or is otherwise in communication with, a mobile endpoint, such as reduced endpoint power consumption or computing demands, and added security, will be readily apparent to a person of ordinary skill in the art.

In some embodiments, the scripting engine 212 collects environment information from assisting modules, including application status modules 216 and application event modules 218. The application status modules 216 communicate with various application-specific APIs 222 (such as presented by virus protection software), third-party SDKs or suites 221 (such as OPSWAT), and the operating system (OS) 223 to obtain OS attributes, such as registry key information. Application event modules 218 can observe attributes for events, such as reboot, changes, new attributes added, and can create the following: a list of viruses found on a device along with date/time when these were found; a list of endpoint intrusion attacks recorded by a personal firewall along with date/time; a list of spywares found on the device along with date/time when these were found; a list of data leak prevention incidents recorded on a device along with date/time when these incidents happened. The event module 218 can also add timestamp information to environment status information collected. The application status modules 216 and application event modules 218 can be part of the scripting engine 212 or separate modules provided by a software suite.

The exemplary visibility agent 210 contains a data upload module 214 that allows the visibility agent 210 to upload the environment status information collected to a server or servers 270. The data upload module can communicate with the server via a network or networks 240, which can include the Internet, a corporate LAN or VLAN, wireless network, or any other network topology available to one of ordinary skill in the art.

By using extensible visibility agents, IT managers can deploy visibility agents that are easily configured to collect information from a wide variety of applications without being tied down to certain security applications offered by a single vendor or to certain operating systems or platforms. Some prior art security vendors provide the various security metrics that are similar to some that are available to a user of the consolidated security dashboard of the present invention. However, the prior art is limited to application categories and specific applications sold by that single vendor. This is partially driven by their business requirements to provide better functionality for their software to help them sell better and partially driven by the technical limitations of their software which is focused on providing security rather than overall device management capabilities. Furthermore, by using the visibility agent approach, the present invention can avoid the problems of the prior art—endpoints need not be within the corporate network or connected via VPN and hosted within the corporate environment to provide information required for deriving security metrics.

The present invention is able to collect security metrics for a wide array of application vendors from multiple vendors' application as well as upload, process, store and report this information. Furthermore, users of the system of the present invention can update the scripts and dashboards to gather new metrics or metrics about new applications without having to redeploy a new dashboard system.

Visibility agents 203, 205, and 210 integrate with a widely array of security applications to query security metrics of relevance to IT Administrators and Security Manager. For this, the visibility agent uses various mechanisms—read set registry keys, log files created, direct API calls as well as third party SDKs like Opswat that in turn query security applications for metrics.

In some embodiments each security metric can be captured as an independent data attribute. For example, the following Anti-Virus security metrics/attributes may be captured by visibility agents 203, 205, and 210:
a) Anti-Virus: Application Name
b) Anti-Virus: Vendor
c) Anti-Virus: Version
d) Anti-Virus: Installed Date
e) Anti-Virus: Status
f) Anti-Virus: Definition Date
g) Anti-Virus: Definition Version

In some embodiments, visibility agents 203, 205, and 210 store and upload the values for various status metrics in a (key, value) format. For example if Symantec Anti-Virus is installed on the computer, values that can be captured and uploaded to backend server could include:
a) Anti-Virus: Application Name, Symantec Anti-Virus
b) Anti-Virus: Vendor, Symantec
c) Anti-Virus: Version, 10.0.1.104
d) Anti-Virus: Installed Date: Aug. 25, 2009
e) Anti-Virus: Status: Running
f) Anti-Virus: Definition Date: Sep. 26, 2009
g) Anti-Virus: Definition Version: Sep. 26, 2009 rev 4

Backend System

In some embodiments, the backend server applications include applications implemented as applications that are part of a security portal that allows the aggregation, analysis, and display of information to an IT user. In some embodiments this security portal includes MaaS360™ applications running on a server or servers 270. MaaS360™ is a security application environment available from Fiberlink Communications Corp. MaaS360™ is only one example of a system that could be used in conjunction with the present invention.

Fiberlink's MaaS360™ Platform provides a centralized, hosted management center for IT operations and security personnel to view detailed information on the health and status of laptops, to control software and security policies on distributed systems, and to manage Wi-Fi, 3G and other wireless networking. The MaaS360 Platform supports visibility, control and Mobile Services. Subscribers to those services use the MaaS360 Platform to consolidate overlapping reporting and management tools, reduce the cost of managing mobile devices, protect data on endpoints, and streamline compliance processes. Using such a portal, a single management center replaces multiple reporting tools and management consoles. IT personnel can view a wide range of reports showing details of installed software applications, missing patches, security, compliance status, wireless networking usage and connectivity costs. Managers can also define and distribute software and security policies from a centralized location.

Backend applications can be hosted by a third party vendor that provides a larger suite of security diagnostic and management software or provided by stand-alone applications maintained within an organization. In some embodiments, an interface including a user interface is provided to customers and partners via MaaS360 or other security application environments. In some embodiments, these security application environments are modified to support the extensible dashboard systems described below.

The backend applications include a datamart wherein the data from the visibility agents are stored. Additionally, it includes datamarts that store the data directly from the security applications, if gathered by the backend applications. Once gathered into the datamart, the backend applications can further compile, aggregate, and prepare the information for presentation and analysis. In some embodiments, the data from various datamarts is moved into a number of application-specific staging mart, which can include a platform-specific or device-specific datamart, and then to a consolidated datamart. The consolidated datamart merges the data from various application specific data sources and stores the data in a de-normalized manner. This can be structured for extensibility to support data from additional data sources. The extensibility can enable the datamarts to support storage of data for multiple applications of a particular type (e.g. the datamart can be vendor, platform, OS, and device agnostic) multiple application versions, and or multiple types of security applications, such that support can be added without replacing or installing new versions of the backend system.

In some embodiments, the server 270 include a plurality of group-specific datamarts 250 for load balancing or group specific handling of data. Groups can be groups of users, endpoints, user groups or other organizational structures. Groups can include, for example, endpoints belonging to a corporate client that is using the services of a third party security manager who operates the server 270. In some embodiments, groups are predefined groups of users or endpoints that have a corporate relationship, such as a department in a corporate network. In other embodiments, groups can be dynamically created to assist in load balancing.

The data from a group specific datamart 250 is processed by a plurality of application-specific datamarts 261, 262, and 263. For example, datamart 261 might include a datamart that extracts, formats, and processes data related to the anti-spyware applications installed on an endpoint. Datamart 261 might include a datamart that extracts, formats, and processes data related to an anti-virus application installed on the endpoint. Datamart 261 might include a datamart that extracts, formats, and processes data related to a platform-specific (e.g. Android, iOS, blackberry, Windows) configurations and attributes installed of a mobile endpoint. The application-specific datamarts 261, 262, and 263 send the processed environment data to a consolidated datamart 280 to allow for aggregation, analysis, and preparation for display by a dashboard. The application-specific datamarts can also cleanse data to ensure accuracy and usability prior to data transfer to the consolidated datamart using filters, schema, templates, or pre-defined mapping logic. This can assist the IT manager treat data from various sources more uniformly, including assisting in applying or creating metrics, filters, heuristics, statistical tools or the like.

In some embodiments, the consolidated datamart 280 has a representation for each endpoint (or a subset thereof) and can include as many records as different application types installed on the endpoint. In case the endpoint has more than one application for any application type, all the different applications and platform information can be captured as separate records for the endpoint, or included in the same record. This data can be stored in a relational database and viewed as a series of rows and columns, where each row represents one endpoint and each column in the Datamart correspond to various relevant attributes related the Application Types. Columns can be generic and are shared across Application Types, specific to a particular Application Type and are left blank for non-applicable Application Types, or any combination of the two.

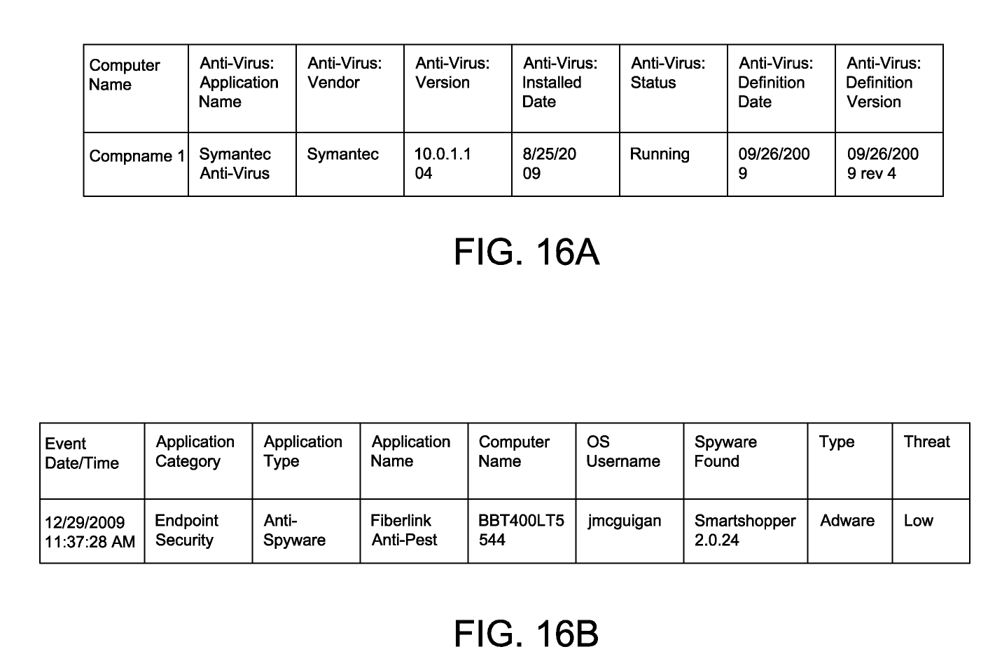

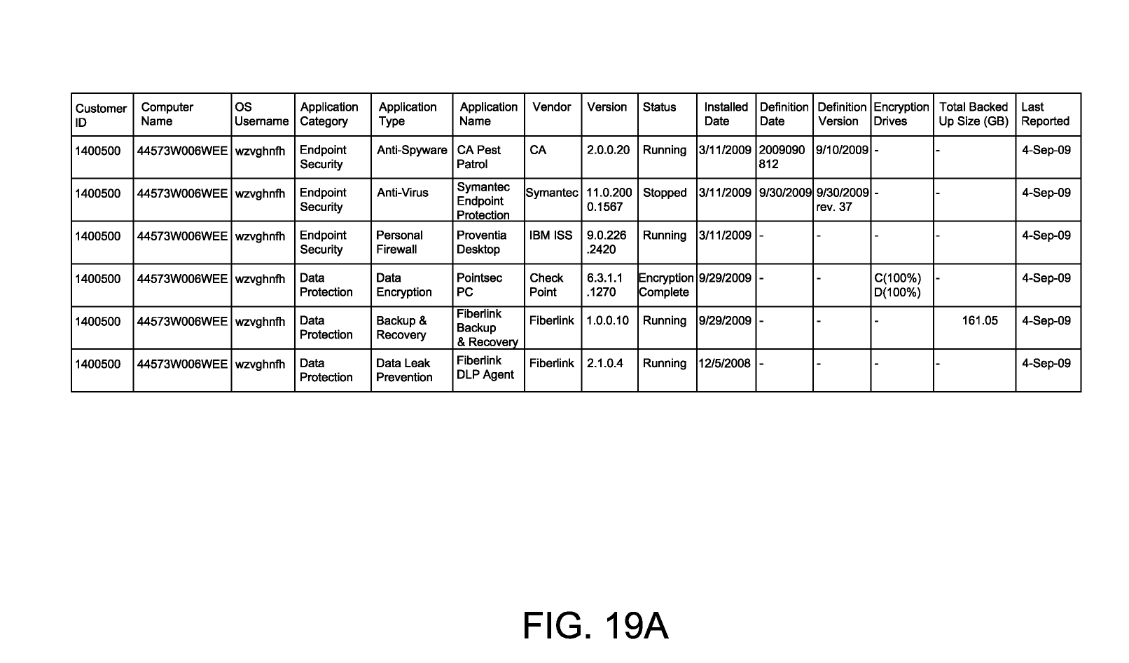

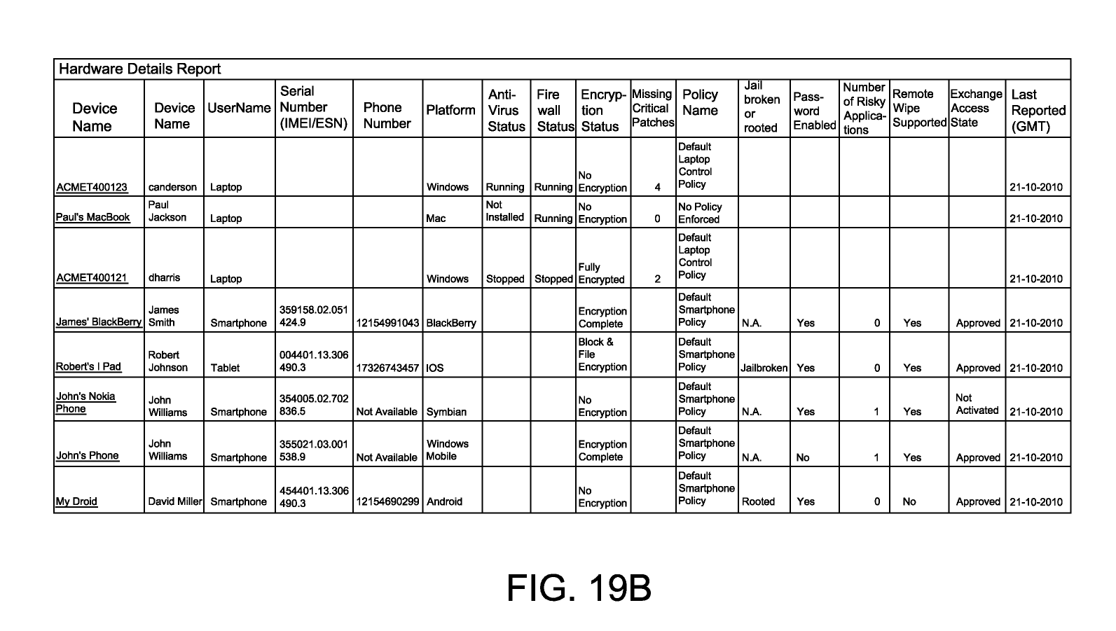

FIG. 16A illustrates an example of an entry in an application-specific datamart that includes status information pertaining to anti-virus application attributes. This can is derived from the key, value pairs obtained by visibility agent 210. In addition to anti-virus attributes of FIG. 16A, the table in the consolidated datamart can include columns for other application categories as well. Example of entries in the consolidated datamart appears in FIGS. 19A and 19B. The example in FIG. 19a includes normalized entries for each application, which include customer ID, Computer Name, OS username, Application category, type, name, vendor, version, status, install date, definition date and version, identity of any encrypted drives, backup size, and last report. The example in FIG. 19B includes normalized entries for pertaining to a mobile device, which include device name, username, device type. serial number, phone number, platform, anti-virus status, firewall status, encryption status, number or ID of any missing patches, name of security policy applied to device, whether the device has been rooted to give the user special access, presence of password protection, number or identity of any known suspicious applications, whether the device is capable of being remotely wiped, Exchange access state, if any, and last report date. These exemplary data tables form the basis for the consolidated security dashboard.

FIG. 16B illustrates an example of an entry in an application-specific datamart that includes event information pertaining to anti-spyware application event attributes. This can is derived from the key-value pairs obtained by visibility agent 210. In addition to anti-spyware attributes of FIG. 16B, the table in the consolidated datamart can include columns for other application categories as well.

In an illustrative embodiment, a sample record that is stored in the consolidated datamart include the following format. For each computer there are multiple records—one record each for the each security application installed on the computer. If there are multiple security applications of a particular application type (e.g. multiple Anti-Spyware software installed on a device), then multiple records will be there—one each for each security application. Each record can include an ‘Application Category’ that can assist in choosing data to display on dashboards. Exemplary application categories include “endpoint security” and “data protection.” The application category indicates which dashboard will later display this information. Each record can include ‘Application Type,’ which indicates the class or type of security application—Anti-Virus, Personal Firewall, Anti-Spyware, Data Encryption, Backup & Recovery, Data Leak Prevention, Peripheral Protection, etc. Each record can further include information of Application Name, Vendor, Version, Status and Installed Date—each as a separate column. Additionally, the entries in the consolidated datamart include some columns that are specific to certain Application Type and will be blank for others. For example Definition Date will have a valid value for Anti-Virus and Anti-Spyware but blank for others since this attribute may not be relevant.

In some embodiments, visibility agents 203, 205, and 210 store and upload the values for various generic attributes (that are common to all Security Application Types) for the Application Status:
a) Application Category
b) Application Type
c) Application Name
d) Vendor
e) Application Version
f) Installed Date
g) Application Status (Possible values: Running, Stopped, etc)

In some embodiments, visibility agents 203, 205, and 210 store and upload Application specific attributes for the Application Status:
a) Anti-Virus & Anti-Spyware:
   1. Application Definition Date
   2. Application Definition Version
   3. Last Scan Date
b) Encryption
   1. Encrypted Drives
c) Backup & Recovery
   1. Last Backup
   2. Backup Limit (GB)
   3. Total Files Backed Up
   4. Total Backed Up Size (GB)
   5. Capacity Used (%)
d) Data Leak Prevention
   1. Policy ID/Name
   2. Last Policy Change Date

In some embodiments, visibility agents 203, 205, and 210 store and upload device attributes and includes:
a) Computer Name
b) Last logged in OS Username
c) Device Type
d) Manufacturer
e) Model
f) Processor
g) Memory
h) Operating System/platform including Service Pack or patches
i) Last known IP Address
j) Serial number
k) Phone number
l) Root status
m) Known suspicious applications

In some embodiments, visibility agents 203, 205, and 210 store and upload the values for various generic attributes for events:
a) Event Date/Time
b) Application Category
c) Application Type
d) Application Name
e) Computer Name
f) OS Username
g) Threat Type (Possible values: Virus, Malware, Adware, Data Leak Incident, Attack, etc)
h) Threat Severity

In some embodiments, visibility agents 203, 205, and 210 store and upload the values for various application-specific attributes for events:
a) Anti-Spyware
   1. Spyware Found
   2. Threat
b) Data Leak Prevention Incidents
   1. User Activity
   2. Incident Description
   3. Action
   4. Policy/Rule Violated
   5. User Response
c) Anti-Virus
   1. File Name
   2. Virus Name
   3. Status
d) Personal Firewall
   1. Attack Category
   2. Intruder Name/IP Address
   3. Parameter(s)
e) Encryption
   1. Files encrypted
f) Backup & Recovery
   1. Files Backed up

Presentation of Information

Exemplary dashboards include endpoint security overview, data protection overview and policy enforcement overview. Dashboards can be configured to read data from the consolidated datamart and showcase the metrics that are relevant from a compliance perspective.

The Endpoint Security Overview includes information about various Endpoint Security applications—Anti-Virus, Personal Firewall, Anti-Spyware, Zero Day Threat Protection and OS Patches. The Data Protection Overview includes information about Data Protection applications—Encryption, Peripheral Protection, Backup & Recovery and Data Leak Prevention. In each of the dashboard, key metrics are configured as Graphical charts and these would highlight the problem areas as well as providing device security posture in a unified view. Metrics can be calculated, derived, or the same as the attributes that are received from the visibility agents.

The Graphs can also support drill-down to detailed reports to show the data underlying the graphs. Detailed reports also include filters that enable analyzing the data using different attributes. In some embodiments, drilling down allows various security metrics to be viewed for the entire endpoint base of the customer or for any groups of endpoints (e.g. endpoints belonging to a particular location or Department, etc.) Furthermore, individual attributes and security metrics of individual endpoints can be viewed by drilling down further.

Details of Data Flow

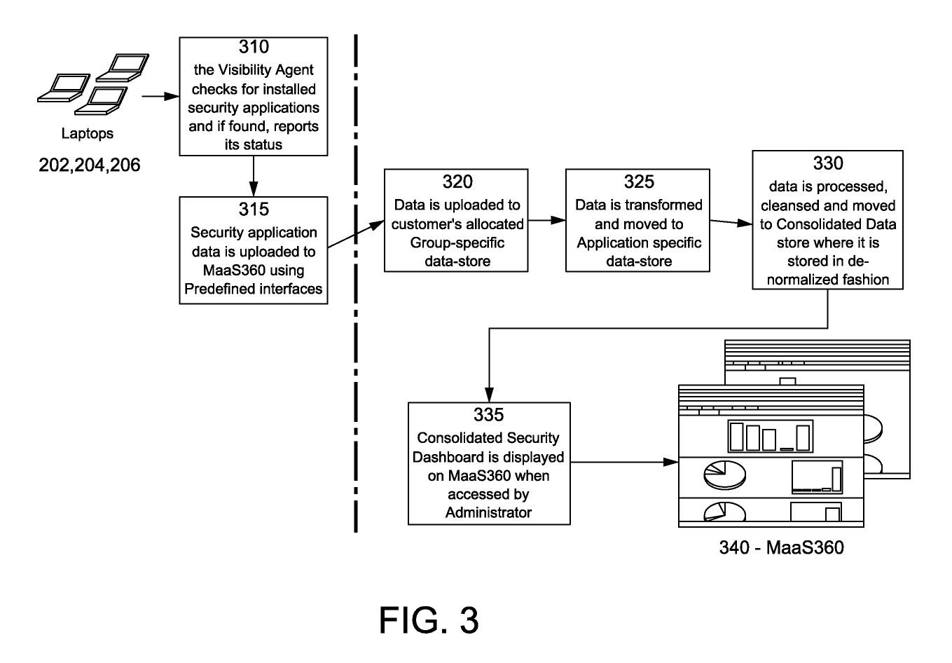

FIG. 3 shows the overall dataflow of the system. Endpoints 202, 204, 206 contain environment data and visibility agents for collecting this data. At step 310, the visibility agent 210 checks for installed security applications and if found, begins reporting the status of these applications. This check can include gathering device specific information pertaining to the device or operating system. The check can be performed by a visibility agent operating on the endpoint or on a gateway or server operated by a third party, such as a Blackberry Enterprise Server, Exchange server, or the like. At step 315, the visibility agent 210 uploads the security application or platform data to the server 270, which is running a MaaS360 management suite using pre-defined interfaces, via the data upload module 214. These steps can be performed periodically with a regular frequency or upon events, such as environment changes or boot-up of the endpoint, or via an API exposed by the endpoint or a gateway in communication with the endpoint. The interfaces used by step 315 can include predefine, configurable, and/or extensible interfaces.

At step 320, the group-specific datamarts 250 receive the data from the visibility agents. This can be via a polling mechanism, periodic transmission by the visibility agent, or involve a negotiated transfer to exchange data from the visibility agent to the group specific datamart. At step 325, data is transferred to the group specific datamarts send the data to the application specific staging marts 261, 262, and 263.

At step 330, These application specific staging marts cleanse and format the data to allow for more uniform storage by the consolidated datamart 280. The resulting data can be stored in a de-normalized fashion, meaning that each application or application type can include attributes that are unique to the application or application type as well as some generic attributes.

At step 335 the consolidated data is displayed on a Consolidated Security Dashboard, such as via MaaS360 when accessed by an Administrator. This can include analyzing, aggregating, or processing the data in any of the ways described herein.

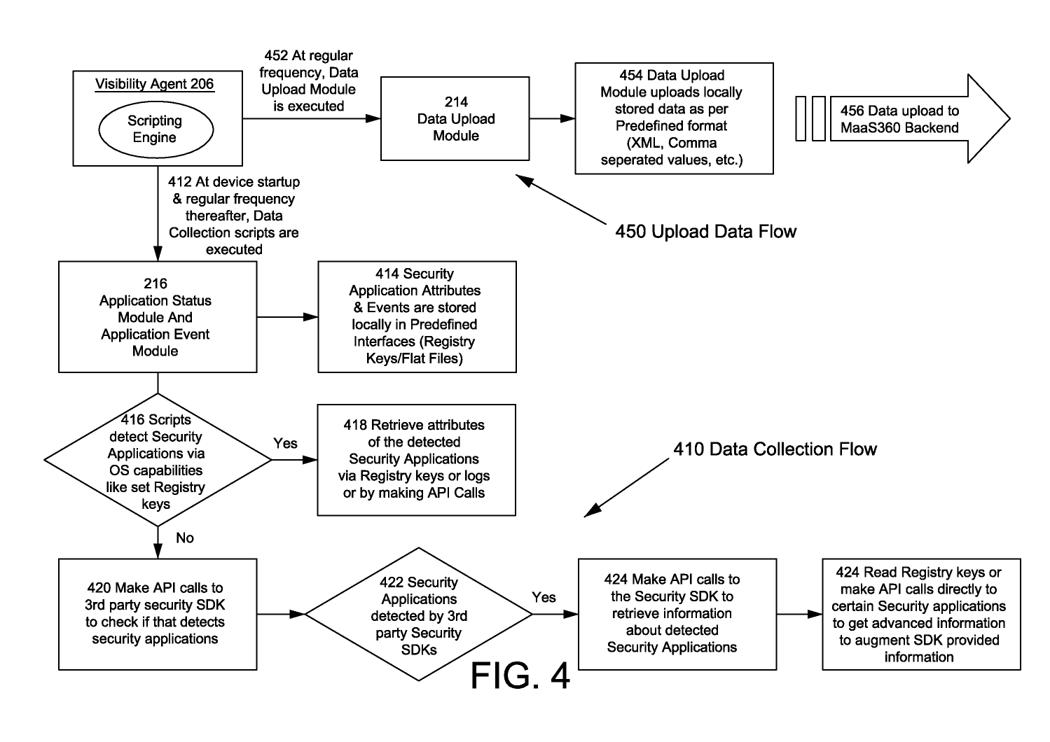

FIG. 4 shows a detailed data flow of an embodiment of the visibility agent 206. Dataflow 410 shows the collection process used by visibility agent 206. At step 412, the visibility agent executes data collection scripts. This can occur at startup and or at regular frequency thereafter, or in response to events in the operation of the endpoint. At step 414, security applications, events, device/platform status and attributes are stored in a predefined manner, such as a registry or flat file. At step 416, the application status modules and application event modules 216 and 218 determine whether the OS can reveal information about security applications and platform status or attributes via the operating system registry keys or flat files, such as comma separated value (CSV) files. If this capability is present, the application status modules and application event modules 216 and 218 retrieve attributes of the detected security applications via registry keys or logs or by making API calls at step 418.

If this capability is not present, at step 420, the application event modules 216 and 218 retrieve attributes by making API calls to 3rd party security SDKs to check for security applications and device attributes. At step 422, the application status modules and application event modules 216 and 218 determine if the 3rd party security SDKs have located attributes of security applications. These SDKs can include custom logic to probe further to determine which information is exposed by security applications via APIs. If so, at step 424, the application status modules and application event modules 216 and 218 make API calls to the security SDK to retrieve information about detected security applications. If no information is available via APIs, in some embodiments, the visibility agent is configured to report to the server that no information is available and the next application or application type is probed.

At step 426, the application status modules and application event modules 216 and 218 read registry keys or make API calls directly to certain security applications to get advanced information to augment SDK provided information.

After data is collected by the application status modules and application event modules 216 and 218, the visibility agent 206 implements the upload data flow 450. At step 452, the visibility agent uses the data upload module 214 to start the upload process. This can occur in response to conditions, requests, or at regular intervals. At step 454, data upload module 214 uploads locally stored data using a predefined format (XML, comma separated values, etc). At step 456, the server receives the data and passes it to the MaaS360 backend

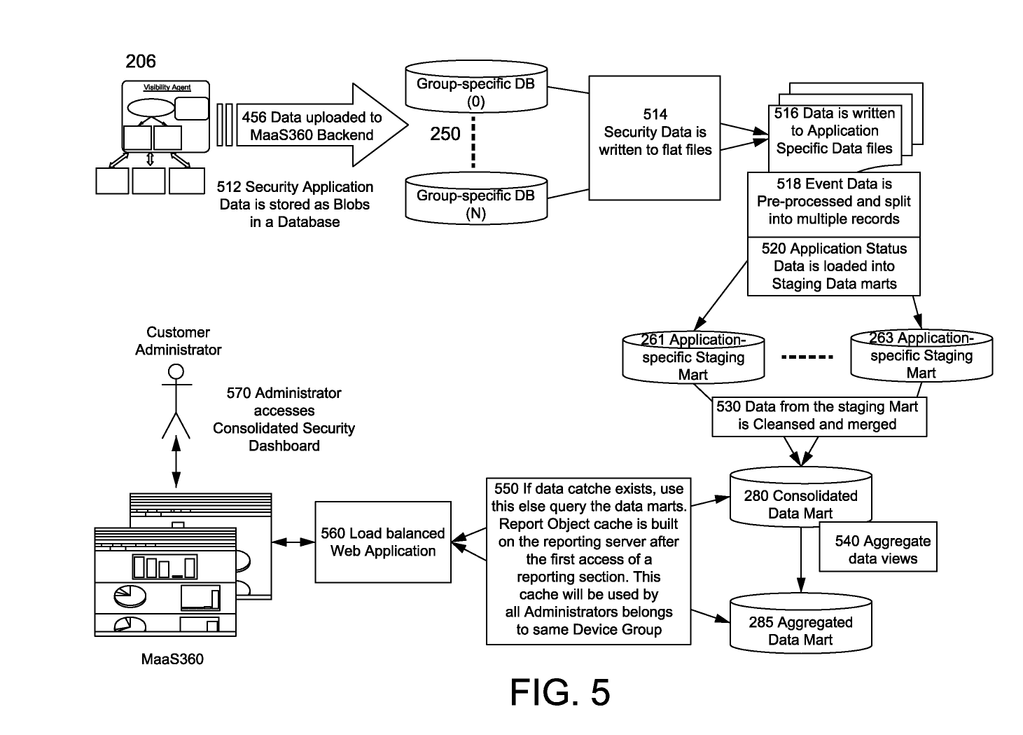

The dataflow on the server is shown in FIG. 5. At step 512, the server takes the data uploaded at step 456 and stores it as blobs. This storage can be implemented in group specific datamarts to aid in load balancing. The group specific datamarts can be implemented as partitions within a larger datamart. At step 514, the security data is optionally written to flat files, such as CSV files, to simplify storage. Optionally, only data for those endpoints that have changes to security data is written At step 516, data is written to application specific files to prepare for storage in application specific datamarts. This allows simplification of storage and handling of the collected information. At step 518, any event-driven data is preprocessed and split into multiple records to assist scalability. At step 520, application status data is loaded into the application specific staging datamarts, such as 261, 262, or 263. For load balancing, data from different groups of endpoint can optionally be saved in different pre-configured partitions within the application specific datamarts.

At step 530, data from the application specific staging marts is merged into a consolidated datamart 280. In some embodiments, the merger includes cleansing the data by verifying that the data meets expected attributes, values, content, etc. This step can also include pre-formatting the data to facilitate the merger of disparate combinations of application/platform specific data from multiple applications, application types, or platforms. Consolidated datamart 280 is used to support security analysis software, such as MaaS360, and provides a backend datamart for the display of data via dashboards. For load balancing, data from different groups of endpoint can optionally be saved in different pre-configured partitions within the consolidated datamart.

In some embodiments, a subset of the data stored in consolidated datamart 280 is aggregated into an aggregated datamart at step 540. This aggregated data can include pre-analyzed data combinations, such as calculated heuristics, statistics, summary information and the like. Consolidated datamart 280 includes individual records pertaining to individual endpoints or applications on endpoints; aggregated datamart includes an aggregation of these records, such as the number of endpoints within a group that have certain attributes, an identification of which endpoints meet certain criteria, or any other aggregated information that may be useful to a person of ordinary skill in the art. The aggregated data allows information used to create graphs and reports to be rendered quickly in dashboards without having to analyze the entire consolidated datamart.

At step 550, data from the consolidated datamart 280 or the aggregated datamart 285 can be stored in a cache to facilitate display and reduce access time when the data is being reviewed via the security application dashboard. When an IT manager or other user accesses the consolidated or aggregated data, such as through a load balanced web application 560, the application can query the cache first before seeking the data in the consolidated 280 or aggregated datamart 285. In some embodiments, step 550 is performed before a query to preload the cache with most common data. In other embodiments, step 550 is only performed in response to queries by an administrator/IT manager/user/security manager (“IT user”) accessing the dashboard (e.g. provided by MaaS360), such as step 570. At step 570, the IT user accesses the consolidated security dashboard to view various data about endpoints and groups of endpoints, including, for example, trends in the security attributes of the endpoints.

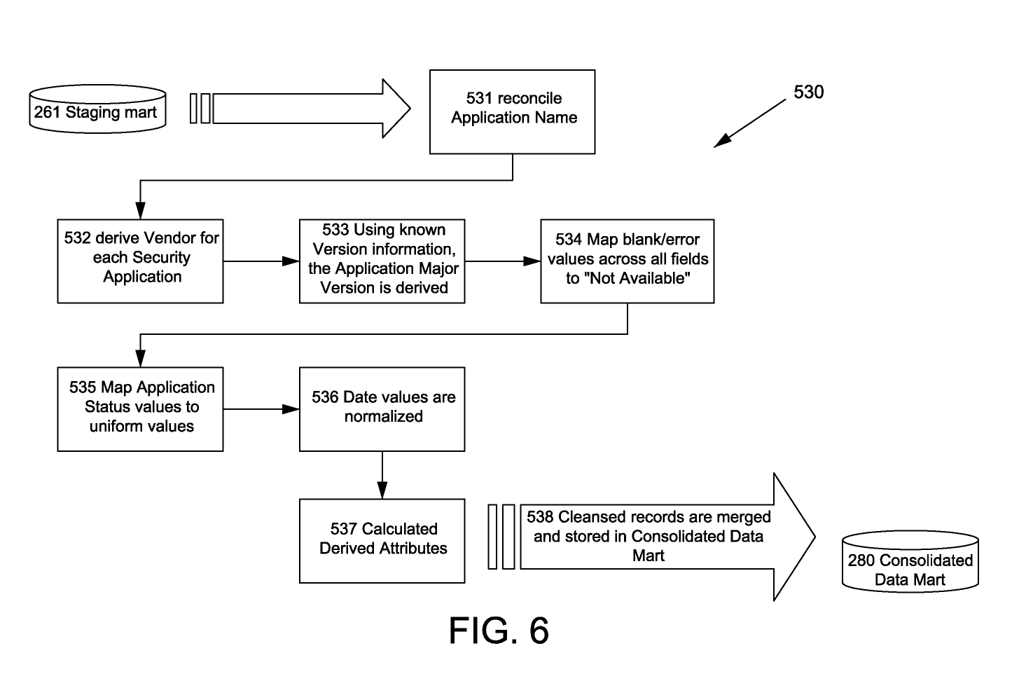

FIG. 6 illustrates an embodiment of the cleansing logic 530. At step 531, data received from the application specific staging mart is handled by reconciling the application name associated with the attributes to conform to a market-facing application name, such as Norton Antivirus. This is accomplished using pre-defined mappings. At step 532, predefined mappings are used to assign the vendor of the security application, such as Symantec. At step 533, the cleansing logic derives application version (which can be used graphs & reports) using known version information. At step 534 any blank/error values located in the attribute data received is mapped to a common value, such as “Not Available.” At step 535 the cleansing logic maps application status values to a set of intuitive/readable/uniform values to enable an IT user to quickly understand and/or compare values to those of other applications or endpoints, e.g. “Enabled.” At step 536, the cleansing logic normalizes date values for uniformity and localization support, e.g. Dec. 31, 2009. At step 537 the cleansing logic calculates derived attributes such as Definition Age, Backup Age, Installed Month & Year, Encrypted Drives & age of Encryption. At step 538 the resulting cleansed records are merged and stored in the consolidated datamart.

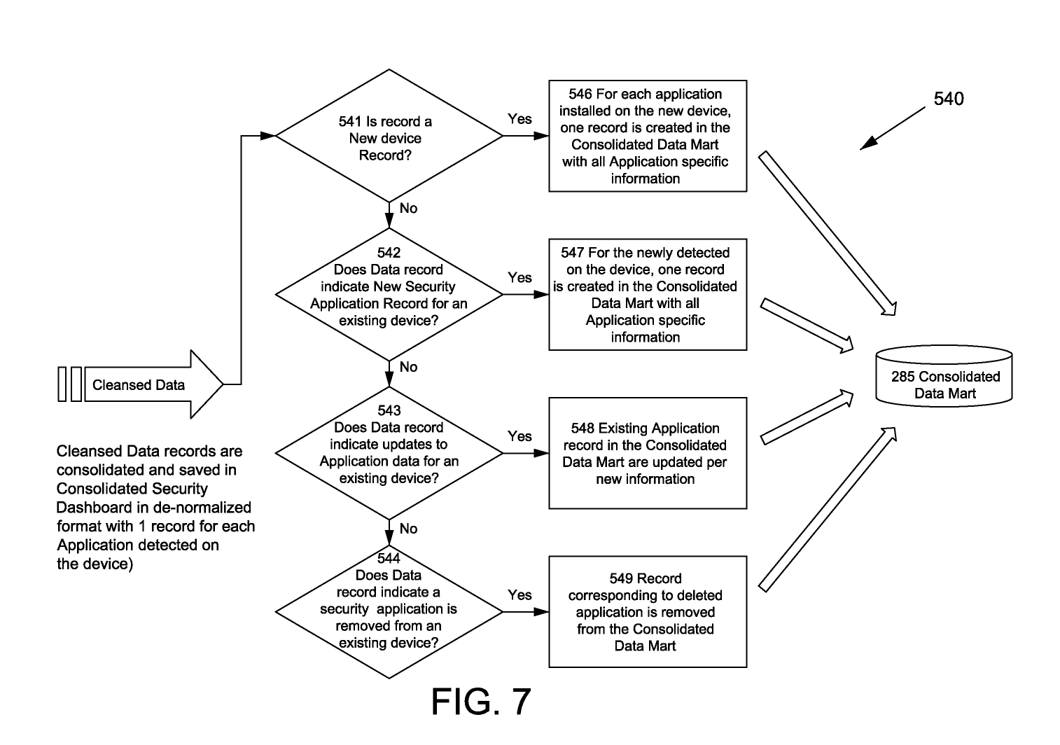

FIG. 7 illustrates an embodiment of the logic for consolidating the cleansed data to store in the consolidated datamart at step 540. In this embodiment, there are four primary situations for consolidating data. At step 541 the logic determines if the record relates to a new endpoint. If so, the logic proceeds to step 546, where for each application installed on the new endpoint, one record is created in the consolidated datamart with all the available application specific information from the record. If the logic determines that the record indicates a new security application record for an existing device (step 542), the logic proceeds to step 547. At step 547, one record is created in the Consolidated Datamart for the newly detected application on the endpoint, with all available application specific information from the record. If the logic determines that the data record indicate updates to application data on an existing endpoint (step 543), the logic proceeds to step 548. At step 548, the logic updates the existing application record in the consolidated datamart to conform to the new attribute information. If the logic determines that the data record indicates that a security application has been removed (step 544), the logic proceeds to step 549. At step 549, the logic deletes and removes the record corresponding to the deleted application from the Consolidated Datamart.

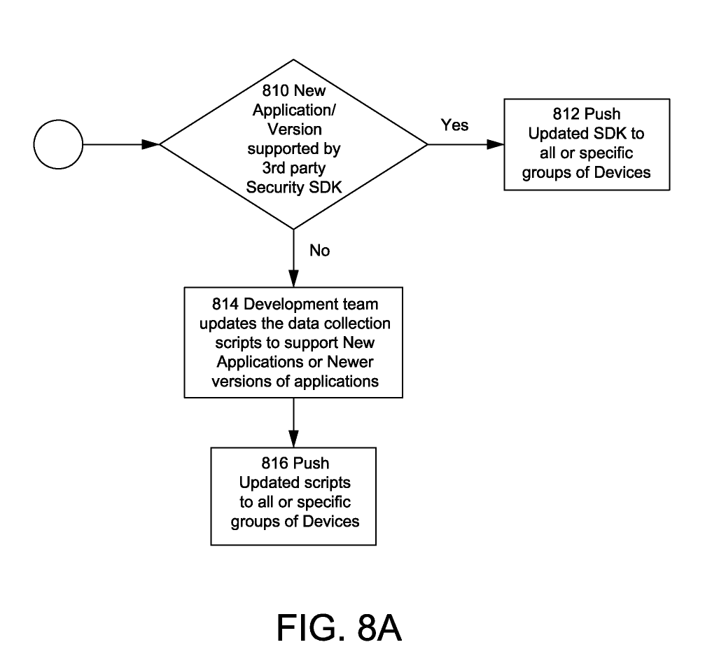

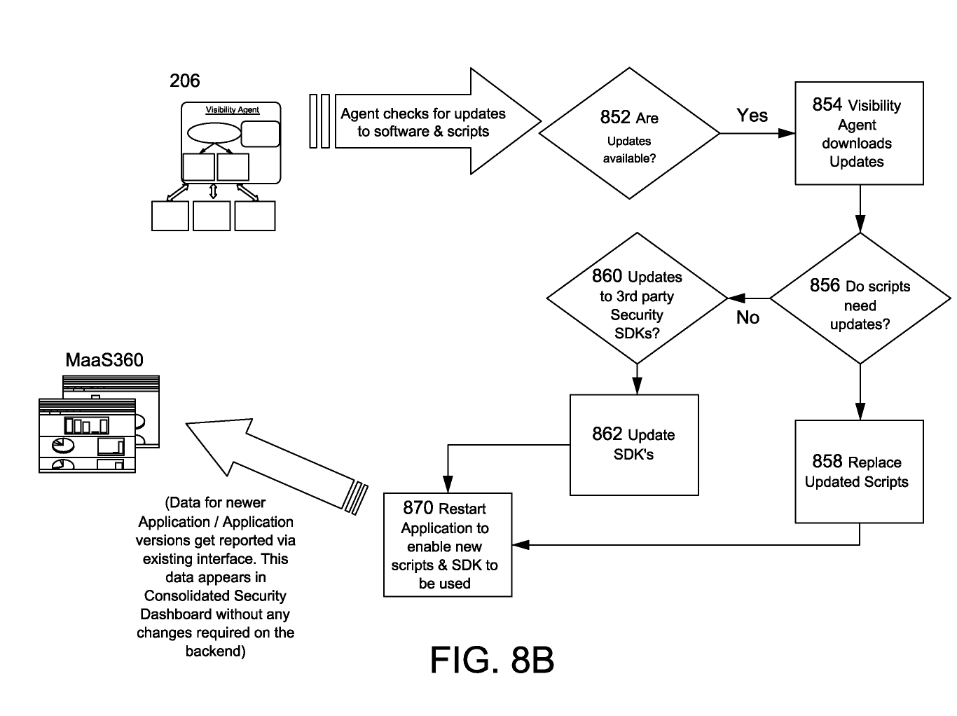

FIGS. 8A and 8B illustrate an embodiment of how an IT user can update the system 200 to accommodate new known security applications or new known versions of existing security applications. In some embodiments, whenever new security applications or newer version of security applications are introduced in the market, only the visibility agent is updated with additional logic to pull security metrics from the application and without any additional enhancements, the consolidated dashboard starts reflecting information about the new security applications or newer version of security applications wherever these are installed in the customer environment.

FIG. 8B illustrates an embodiment of system 200 where new applications or new versions of existing applications become available. At step 810, the software determines if the new application or version is compatible with existing third party SDKs already available to the visibility agents on the endpoint systems. If so, any existing update to the SDK is pushed out at step 814 to the visibility agents on the endpoints (or a group thereof). This allows the visibility agents to gather information where the new application or application version is present on the endpoint. If no existing solution is known, a development team, such as a vendor or a team within an organization, updates the data collection scripts that will be executed by scripting engine 212. In some embodiments, the new or updated script will specify reading new registry keys that may be set by the new application or invoking APIs provided for query status information about the new application. At step 816, the updated scripts are pushed out to the visibility agents on the endpoints (or a group thereof). The pushing performed by steps 812 and/or 816 could include actively sending the updates to the visibility agents or sending the updates at the request of the visibility agent for the latest updates.

Once the updates are available, the visibility agent 206 determines if new updates are available at step 852. This determination can be by using any method known in the art, such as sending a request to the server at endpoint boot up. If so, the visibility agent can download the updates at step 854. Once the updates have been downloaded, the visibility agent can examine the update and determines at step 856 if the update requires updating the local scripts. If the scripts contain updates to the scripts, the visibility agent modifies, adds, or replaces the scripts in the local store of scripts to be executed by the scripting engine 212. Then, the visibility agent application on the endpoint is optionally enabled to enable the scripting engine to handle the new scripts at step 870. If the visibility agent determines that the scripts do not need to be updated at step 856, the visibility agent proceeds to step 860. At step 860 the visibility agent can determine if the update pertains to the third party SDK. If so, the visibility agent updates the SDK at step 862. The visibility agent then proceeds to step 870 and is ready to gather information about security applications using the new updates. Data for newer application/application versions get reported via the existing interface. On the server-side, this data appears in Consolidated Security Dashboard without any changes required on the backend.

In some embodiments, an IT user or vendor can also define a new security application type. An example of a new type might include preventing, controlling or encrypting data transferred to a removable media drive. If this application type was not previously defined in system 200, the IT user or vendor can use the update system described in FIG. 8B to create new scripts to be used by the visibility agents (in script module 212) for gathering attributes of the new application type. The update system can also be used to define a new interface for the visibility agent to use when uploading the information gathered for the new application at step 456. The IT user or vendor can also define new application specific data file formats to be used on the server side for use with step 516 for storing the gathered data to application specific datamarts 261, 262, and 263. The IT user or vendor can also define new application specific datamart to be used on the server side for storage of the new file format data. The IT user or vendor can also update the dashboards to be used by IT users when viewing the new application data. Because the modification to the backend server is minimal, and largely limited to adding new formats and datamarts, the impact of the additional security application type is minimal and can be done without rolling out a new application suite and minimizes or eliminates any server downtime. Furthermore, the manner in which attributes are collected by visibility agents and stored on the backend server allow these components to scale up and be modified with little effort.

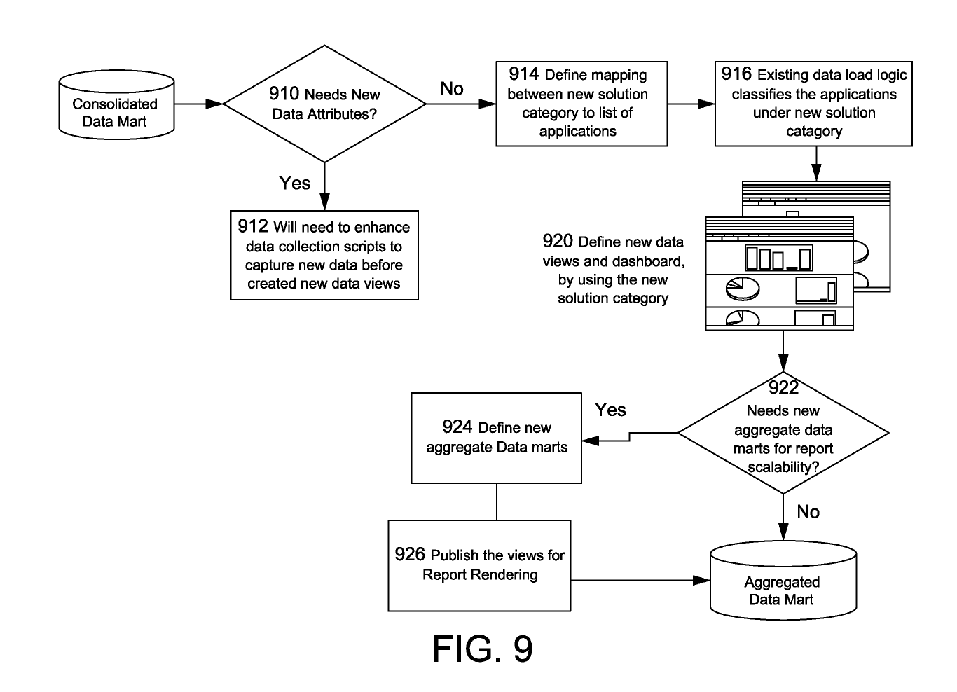

FIG. 9 shows an embodiment of the data flow to define new dashboard views to be displayed to the IT user when viewing data from the consolidated datamart. No update to visibility agent or client-side information is needed for the dashboard changes because the dashboard works with the existing data that has been gathered by the existing visibility agent deployment. At step 910, the software or IT user determines if the new dashboard view requires attributes that are not gathered by existing visibility agent deployment. If so, at step 912, the IT user will need to update current scripts or SDKs in accordance with FIGS. 8A and 8B before the new dashboard view can be implemented.

If no new attribute information is needed, then at step 914 the IT user or software defines a mapping between the solution category of the new dashboard view to the security applications about which attribute information is currently gathered. In some embodiments, available solution categories include endpoint security (e.g. Anti-Virus, Personal Firewall, Anti-Spyware and Zero Day Threat Protection) and data protection (e.g. data back up, encryption, etc.). The new dashboard can include new solution categories not already available in these embodiments.

Once the solution category is mapped to a list of available applications at step 914, at step 916, existing data load logic classifies the applications mapped to this solution category. In some embodiments, each application type belongs to one or more solution categories. For example, anti-virus might belong to the “Endpoint Security” category. When data gets loaded into consolidated Datamart, all records with Application Type=“Anti-Virus” are marked with Solution Category=“Endpoint Security”. This category is used by the dashboard system to determine which records are relevant to the selected dashboard. For example, during Endpoint Security Dashboard rendering, only records with Solution Category=“Endpoint Security” are included and other solution categories can be ignored.

At step 920, the IT user can define the new views to be displayed in the dashboard to use with this new solution category. This can include a selection of layout, analysis methods to apply, and the type of display objects to use (e.g. bar graphs, charts, etc.)

At step 920, the software or user determine if the existing pre-analyzed data in aggregate datamart is sufficient to be used with the new dashboard view. If new aggregate data is needed, the user or software defines the new aggregation data and or datamarts at step 922. Once the aggregate data is defined, the software computes the new aggregate data views from the consolidated datamart and places the new aggregated data into the aggregated datamart at step 926.

The data flow for event data is very similar to that of the Status data. The visibility agent (application events module 218 in the visibility agent) detects and records the various events logged by security applications on the device. This can be done by reading registry keys, APIs, 3rd party security SDK or event log files. The visibility agent uploads the data to the backend server using the mechanisms described above. The backend server processes, cleanses and stores the event data in the Consolidated Data Mart. The event datamart supports events across all existing application types and is extensible to support newer application types introduced in future.

Exemplary Dashboards

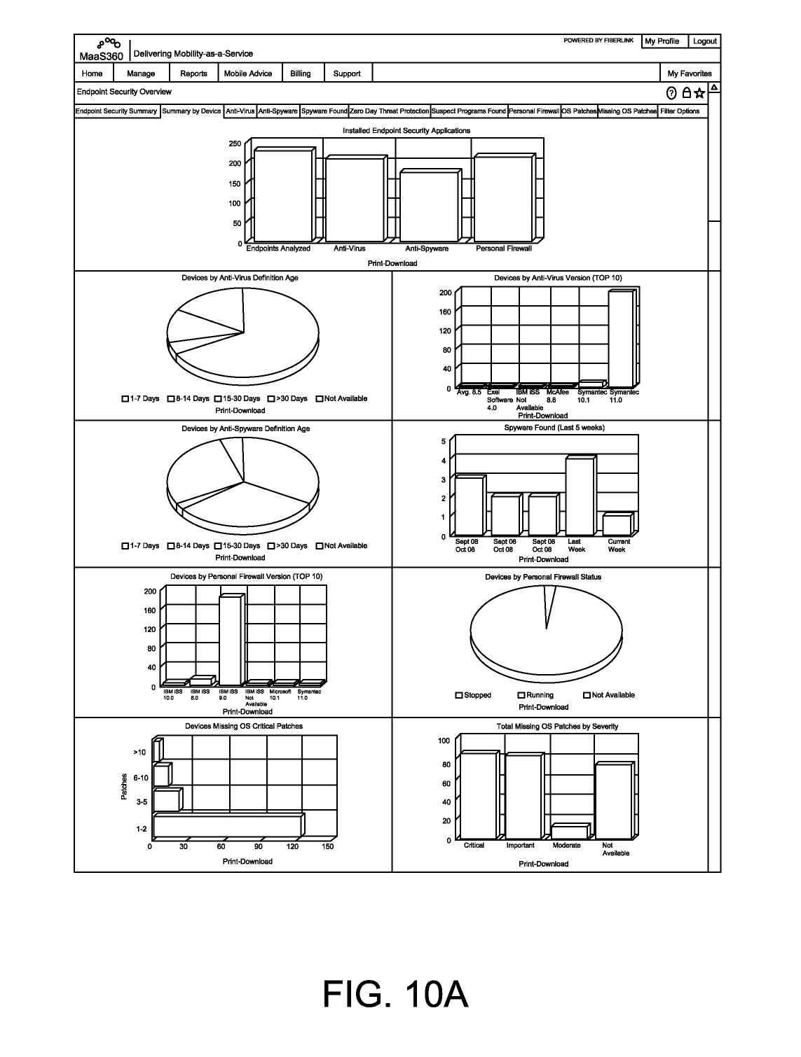

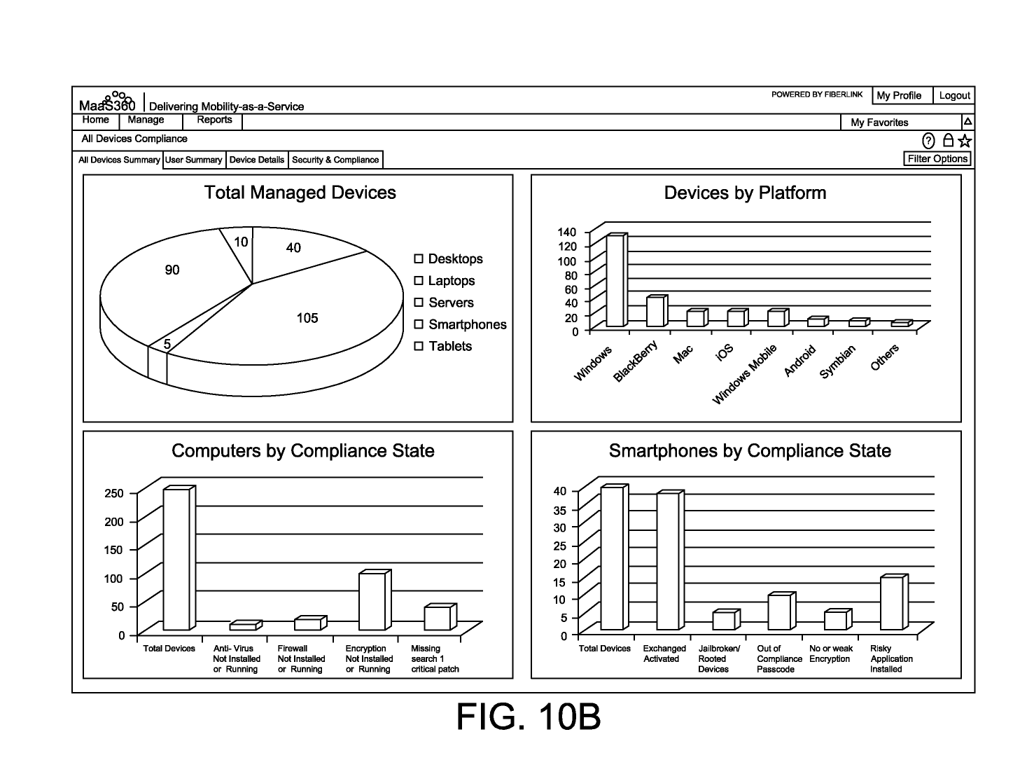

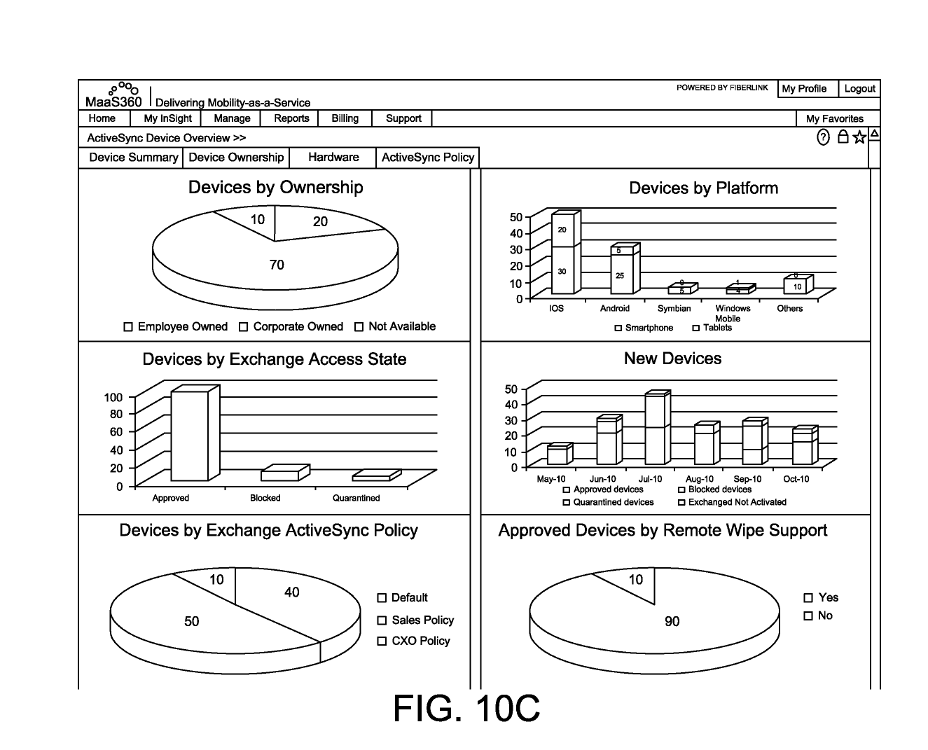

A first exemplary dashboard to be used with some embodiments is the Endpoint Security Overview (ESO). An embodiment of an ESO is shown in FIGS. 10-12. The ESO provides a customer IT user a consolidated view to the security of a group of endpoints. This dashboard highlights key security metrics about the following endpoint security applications on the devices in the customer environment—Anti-Virus, Personal Firewall, Anti-Spyware and Zero Day Threat Protection. Security metrics might include: whether each category of security application is installed or not; details of the security application installed (in each category)—Vendor, Name, Version, Definition Date, etc.; status of the security application—Running or Not, Last Scan Date, etc; and highlights status of various OS Patches on the devices. In the exemplary embodiments in FIGS. 10A-C, statistics about the security metrics, such as the number or percentage of endpoint systems meeting the metrics, are displayed in summary form in various charts and graphs to allow for a quick understanding of the trends within the endpoint group. For example, in FIG. 10A, summary information is displayed in graph form, including graphs summarizing statistics, including:
a) Number or percentage of endpoints containing various classes of security applications, such as anit-virus;
b) Age of antivirus definition frequency of version used
c) Age of anti-spyware definition and how much spyware has been recently removed;
d) Versions of personal firewall used ans status; and
e) Devices missing critical OS patches and severity.

For example, in FIG. 10B, summary information is displayed in graph form, including graphs summarizing statistics, including:
a) Number or percentage of endpoints by type (e.g. server, smartphone, laptop);
b) Number or percentage of endpoints by platform (e.g. Windows, Android, iOS);
c) Number or percentage of endpoints meeting predefined security metrics (e.g. antivirus running/not, firewall running/not, encryption enabled/not, missing set number of critical patches); and
d) Number or percentage of endpoints by mobile compliance state (e.g. Exchange ActiveSync enabled, rooted, using compliant passcode, encryption used, risky applications used)

For example, in FIG. 10C, summary information about certain mobile devices is displayed in graph form, including graphs summarizing statistics, including:
a) Number or percentage of endpoints by ownership type (e.g. personal, enterprise);
b) Number or percentage of endpoints by platform (e.g. Windows, Android, iOS);
c) Number or percentage of endpoints by Exchange access type (e.g. approved, blocked, quarantined);
d) Historical trends of Exchange access type;
e) Number or percentage of endpoints by Exchange ActiveSync policy (e.g. approved, blocked, quarantined);
f) Number or percentage of endpoints by remote wipe capability (e.g. approved, blocked, quarantined);

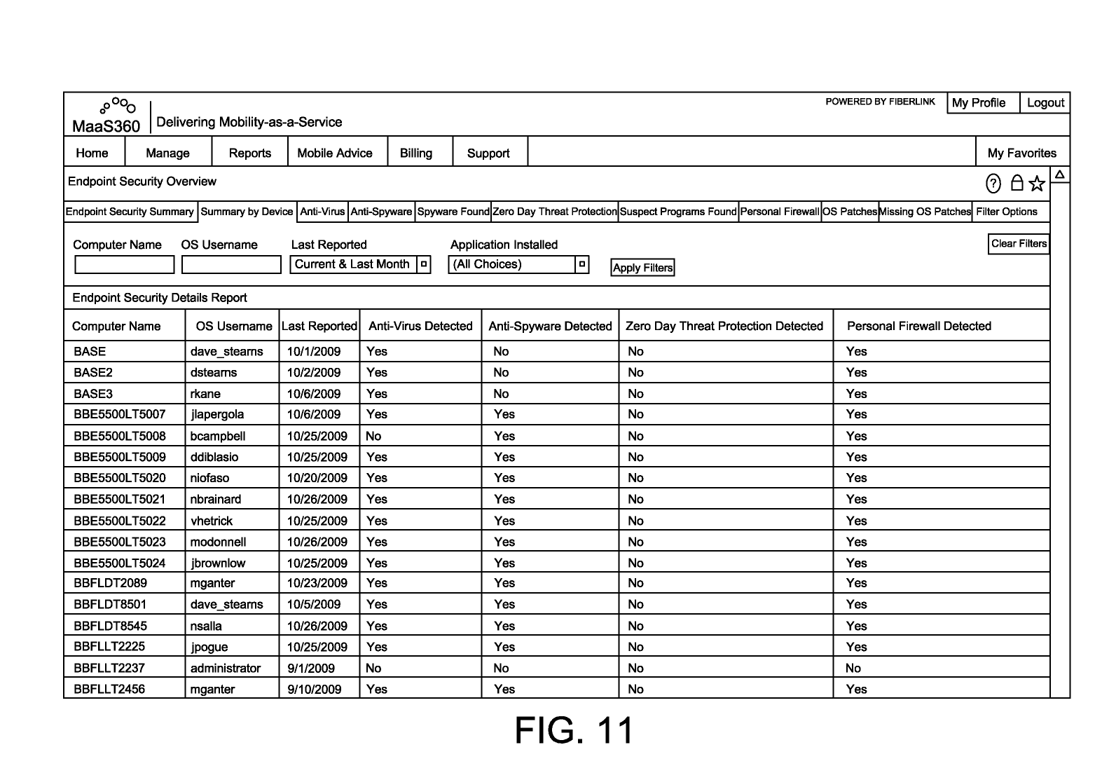

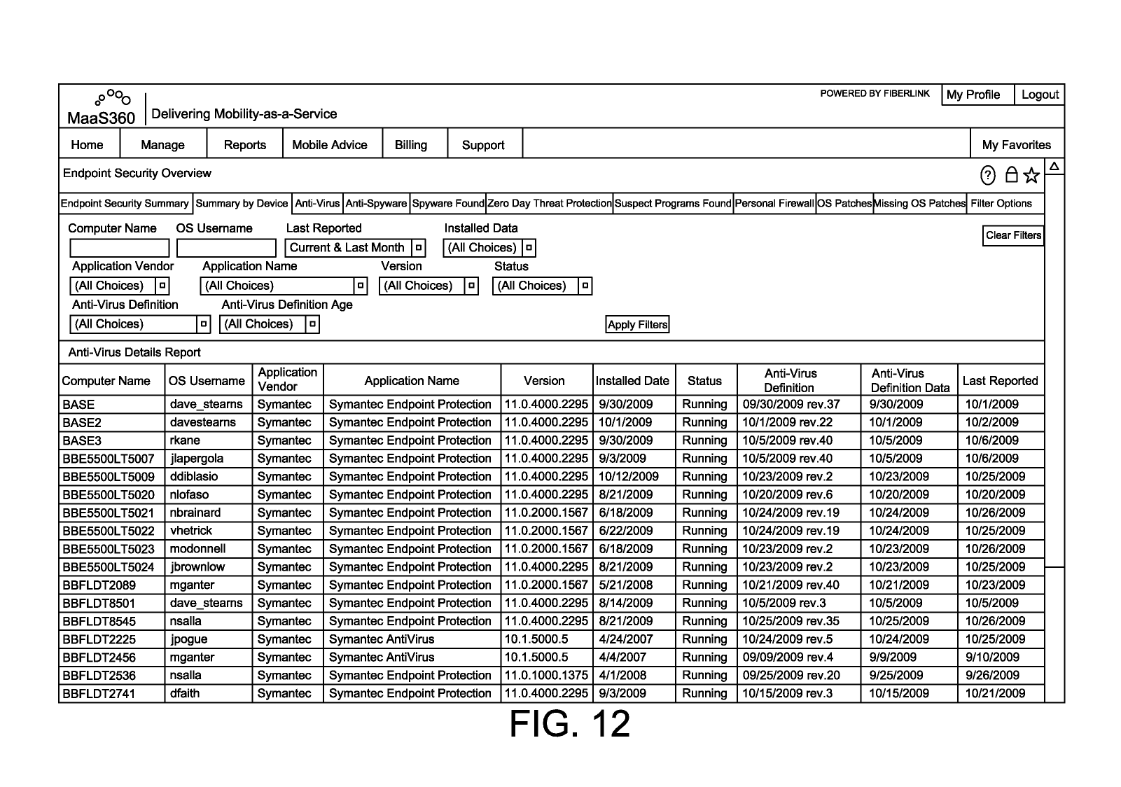

The ESO can also include a detailed table showing the metrics or application attributes for each endpoint within a group displayed in tabular report form for quick and uniform review by IT users, as shown in FIGS. 11 and 12.

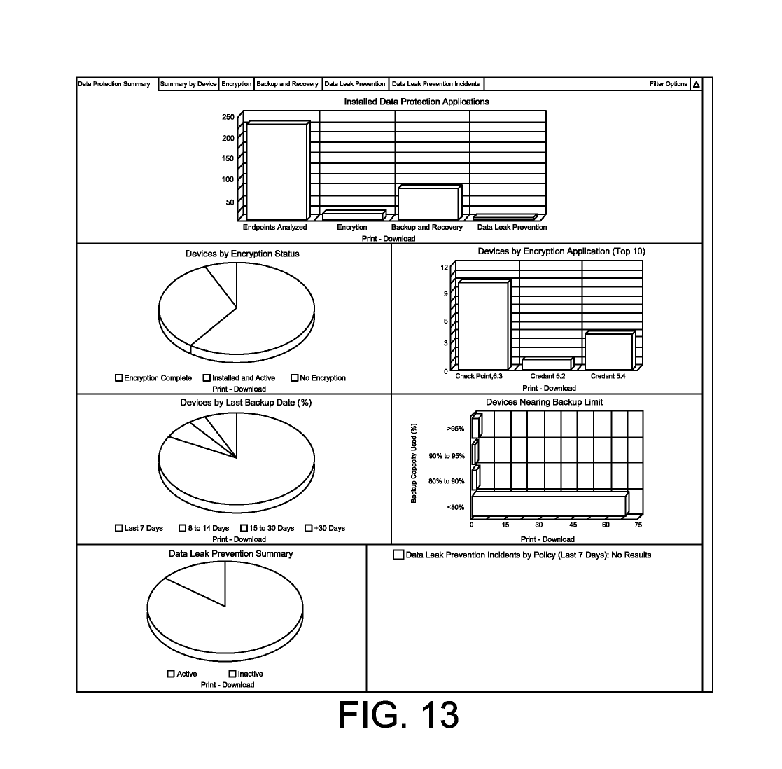

Another exemplary dashboard to be used with some embodiments is the Data Protection Overiew (DPO). An embodiment of a DPO is illustrated in FIGS. 13-15. Similar to the ESO, the DPO provides an IT User a consolidated view to security of data that resides on the computers in a group of endpoints. This dashboard highlights key security metrics about the following data security applications on the devices in the customer environment—Data Encryption, Peripheral Protection, Backup & Recovery, Data Leak Prevention. Security metrics can include: whether each category of data security application is installed or not; Details of the data security application installed (in each category)—Vendor, Name, Version, etc.; and status of the security application—Running or Not, Encrypted Drives, Backup Size, etc. In the exemplary embodiment in FIG. 13, statistics about the security metrics, such as the number or percentage odd endpoint systems meeting the metrics, are displayed in summary form in various charts and graphs to allow for a quick understanding of the trends within the endpoint group.

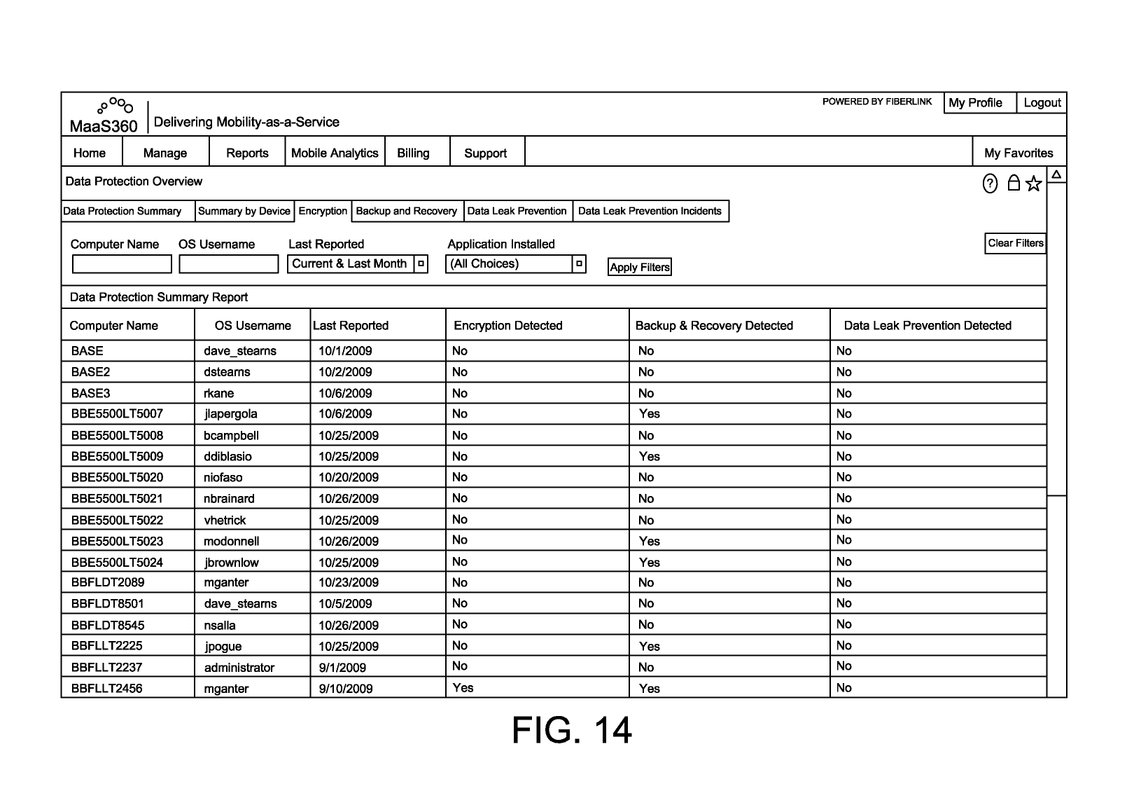

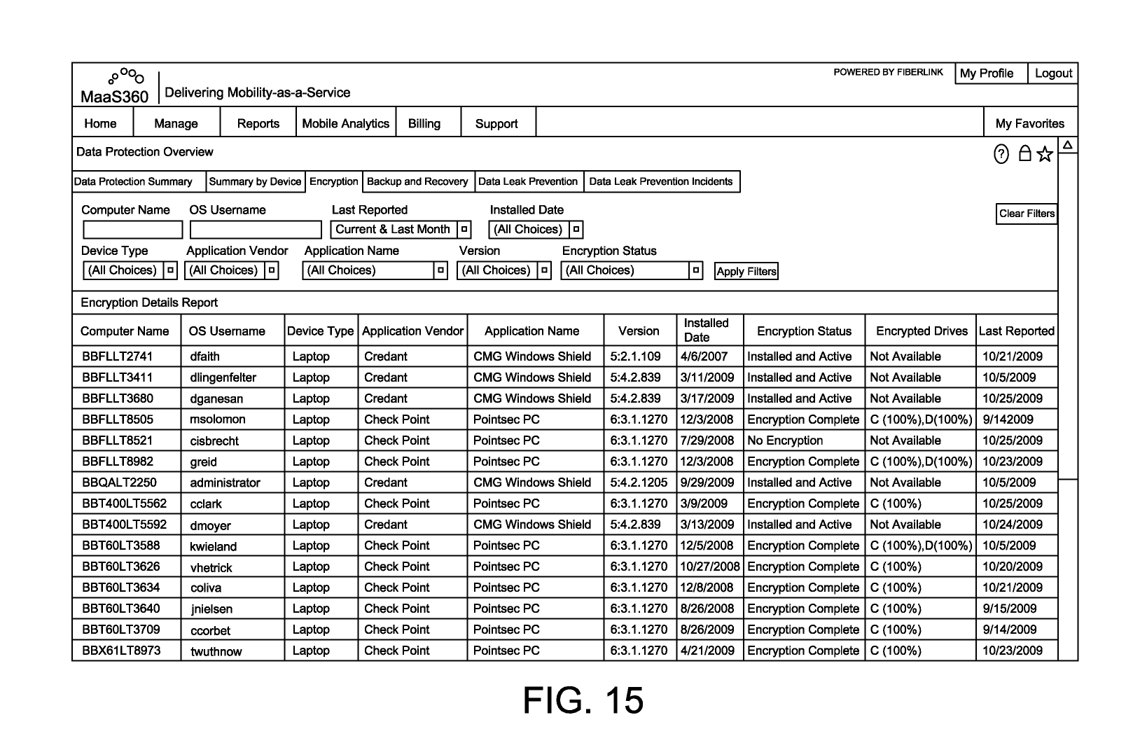

The DPO can also include a detailed table showing the metrics or application attributes for each endpoint within a group displayed in tabular form for quick and uniform review by IT users, as shown in FIGS. 14 and 15.

In some embodiments, these dashboards enable IT Administrators and Security Managers to view and analyze one or more following information scenarios:

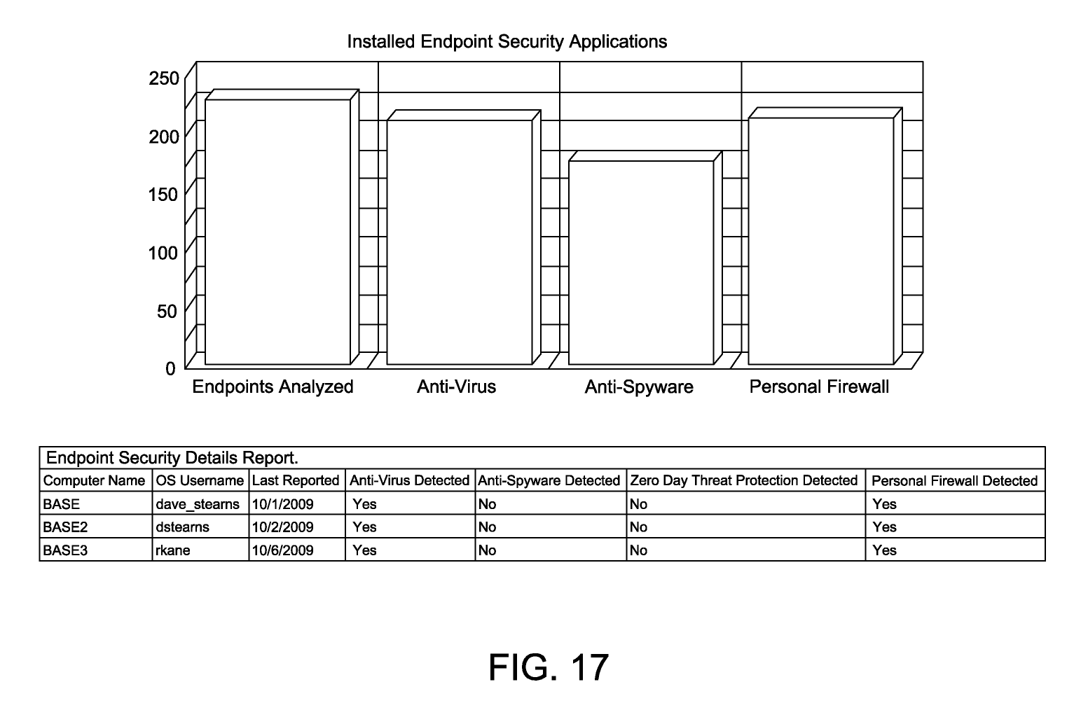

A first exemplary scenario includes determining which devices have security applications installed and which endpoints are missing critical security applications. At a summary level, each of the Consolidated Security dashboard includes an “Installed Applications’ graph that outlines the number of devices on which a visibility agent is installed and the number of devices on which each category of security application is installed. The difference between the two is indicative of the number of devices on which the security application is missing. At a detailed level, each consolidated dashboard includes a device level Summary report that indicates whether security application is installed or not. Exemplary dashboard views for this scenario can be seen in FIG. 17.

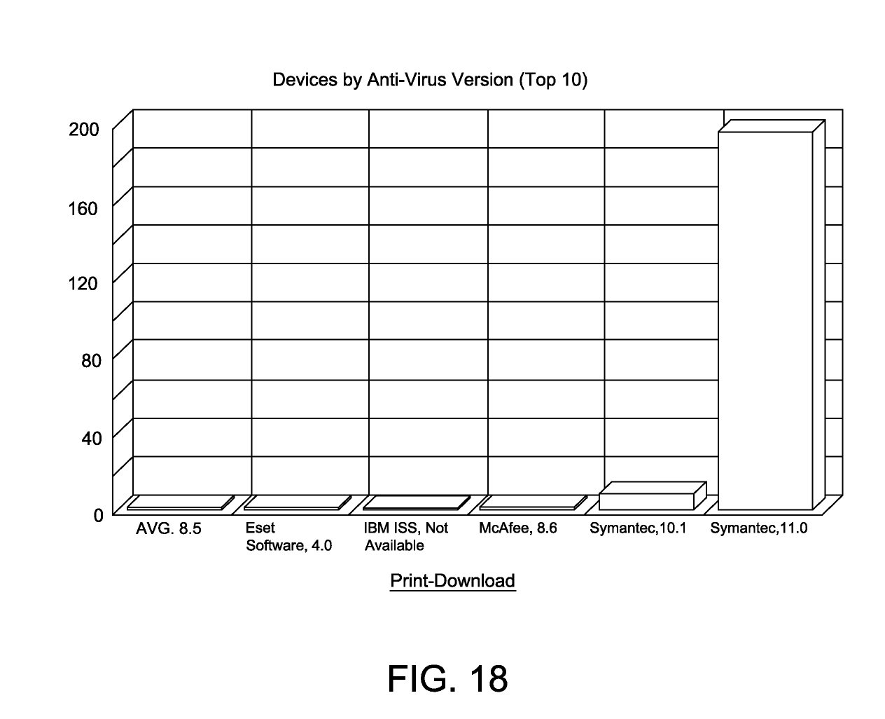

Another exemplary scenario includes allowing an IT manager to quickly understand the different vendors and applications installed in the customer environments on endpoint systems. Consolidated dashboards can include a graph that indicates various applications installed on the computers in the customer environment. As an example, the graph in FIG. 18 highlights various Anti-Virus applications installed.

Another exemplary scenario includes allowing an IT manager to understand the timing of applications deployed on the device so as to track deployments and migrations. The detailed reports in the consolidated dashboard highlight the currently installed version of the security application on each device in the customer environment and when was it installed. This information can be used by the IT Users to plan as well as track deployment and migration of security applications. An example of this information on the dashboard can be seen in the table shown in FIG. 12.

Another exemplary scenario includes allowing an IT manager to know the current status of applications on endpoint systems. The detailed reports in the consolidated dashboard highlights various application status information about devices in the customer environment. For example, the dashboard indicates whether the application is running or not and the date of last application update. An example of this information on the dashboard can be seen in the table shown in FIG. 12.

Another exemplary scenario includes allowing an IT manager to discover potential application issues where endpoint has not reported for a certain amount of time. In some embodiments, each device record has a date “Last Reported”, when the backend server last synced with the computer. This information can be used to determine if endpoints are healthy and sync-ing information back to the backend server. In case of security attack, it is very likely that security applications including the visibility agents are deactivated on the endpoint and hence the endpoint may not report back. An example of this information on the dashboard can be seen in the table shown in FIG. 14.

Another exemplary scenario includes allowing an IT manager to showcase key application-specific metrics that highlight specific compliance issues within groups of endpoints. A first example includes a “Devices by Anti-Virus Definition Age” graph that can highlight devices with very old Anti-Virus Definition Date. Many companies have a strict policy that AV Definition Date should not be older than a few days (e.g. those governed by PCI compliance need to have an AV Definition Date no older than 7 days). A second example includes a “Devices by Personal Firewall Status” graph that can highlight devices that do not have a personal firewall running. Many companies have a strict policy that client computers operate a personal firewall (e.g. Those governed by PCI compliance need to have a personal firewall installed and running on all devices). A third example includes a “Devices by Encryption Status” graph that can highlight devices with drives that are not encrypted. Encryption is commonly required for companies governed by PCI compliance. A fourth example includes a “Devices by Last Backup Date” graph that can highlight devices that haven not backed up for a long time. Many companies stipulate that all data should be regularly backed up to ensure disaster recovery.

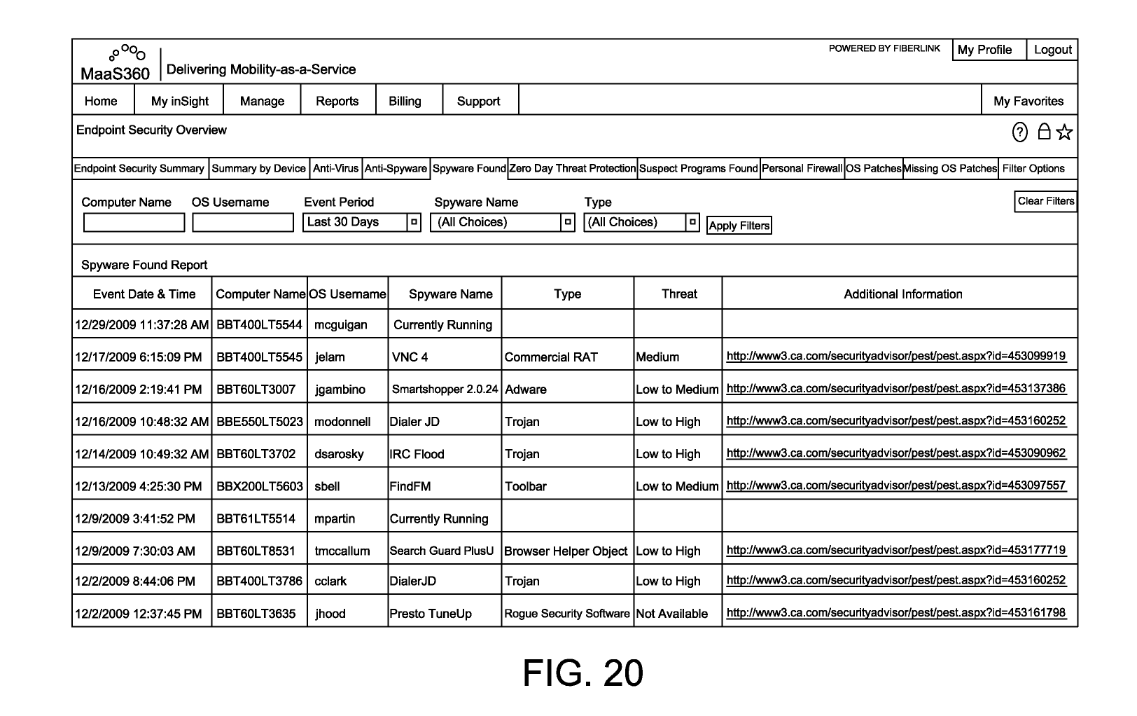

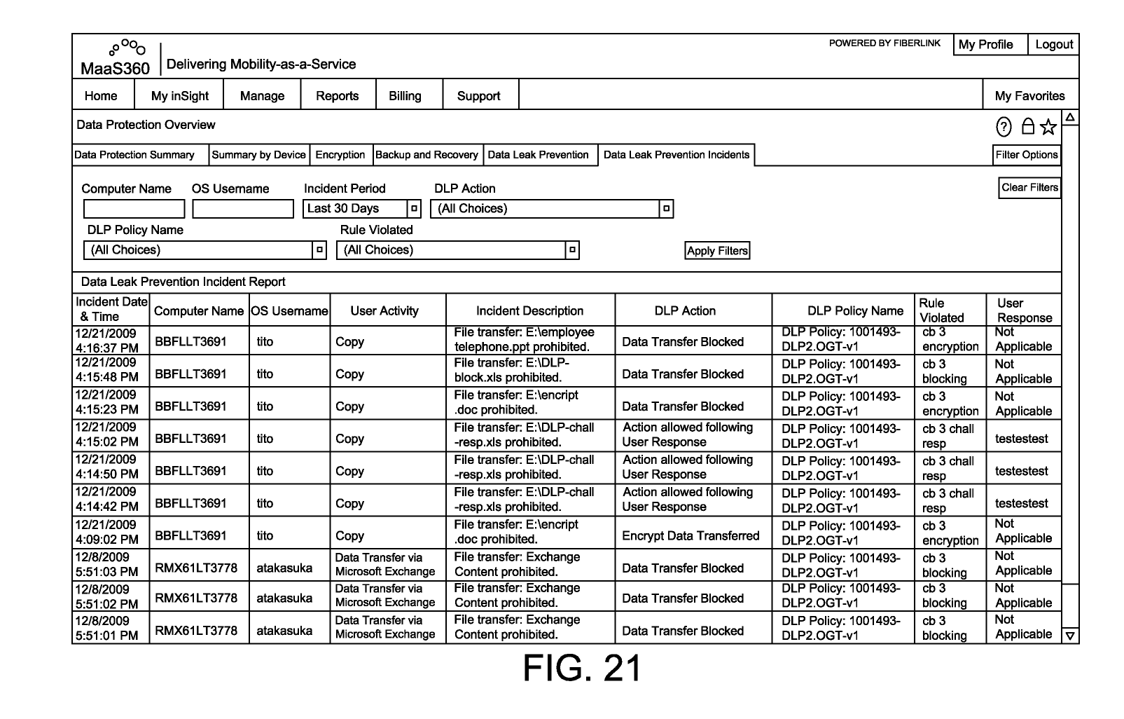

The dashboards can also be used to drill down to review event logs pertaining to threats. For example, FIG. 20 shows an exemplary report of spyware events on a group of endpoints. FIG. 21 shows an exemplary report of data loss events on a group of endpoints.

The exemplary embodiments detailed herein have included security application metrics as an illustrative example. Further embodiments of this invention can include collecting and analyzing information related to installation and status of business applications, usage/tracking of expensive or limited licensed software, installation and status of restricted applications (like P2P software, chat applications, etc) within an organization.

FIG. 1 illustrates an exemplary computing environment 100 within which embodiments of the invention may be implemented. Computing environment 100 may include computer system 110. Computer system 110 is one example of a general purpose computing system upon which embodiments of the invention may be implemented. Computers and computing environments, such as computer 110 and computing environment 100 are known to those of skill in the art and thus are described briefly here. Computer 110 can include, for instance, a desktop, laptop, tablet, mobile device, such as a phone, or other computing device.

As shown in FIG. 1, the computer system 110 includes a bus 121 or other communication mechanism for communicating information, and a processor 120 coupled with the bus 121 for processing the information. The computer system 101 also includes a system memory 130 coupled to the bus 121 for storing information and instructions to be executed by processor 120.

The system memory 130 may include computer storage media in the form of volatile and/or nonvolatile memory such as read only memory (ROM) 131 and/or random access memory (RAM) 132. The system memory RAM 132 may include other dynamic storage device(s) (e.g., dynamic RAM (DRAM), static RAM (SRAM), and synchronous DRAM (SDRAM). The system memory ROM 131 may include other static storage device(s) (e.g., programmable ROM (PROM), erasable PROM (EPROM), and electrically erasable PROM (EEPROM). In addition, the main memory 130 may be used for storing temporary variables or other intermediate information during the execution of instructions by the processor 120.

A basic input/output system 133 (BIOS) containing the basic routines that help to transfer information between elements within computer 110, such as during start-up, may be stored in ROM 131. RAM 132 may contain data and/or program modules that are immediately accessible to and/or presently being operated on by central processing unit 120. System memory 130 additionally may include, for example, operating system 134, application programs 135, other program modules 136 and program data 137.

The computer system 110 also includes a disk controller 140 coupled to the bus 121 to control one or more storage devices for storing information and instructions, such as a magnetic hard disk 141, a removable media drive 142 (e.g., floppy disk drive, read-only compact disc drive, read/write compact disc drive, compact disc jukebox, tape drive, removable magneto-optical drive, and flash memory). The storage devices may be added to the computer system 110 using an appropriate device interface (e.g., a small computer system interface (SCSI), integrated device electronics (IDE), enhanced-IDE (E-IDE), direct memory access (DMA), or ultra-DMA.

The computer system 110 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 110 may also include a display controller 165 coupled to the bus 121 to control a display or monitor 165, such as a cathode ray tube (CRT) liquid crystal display (LCD), LED, AMOLED, touch screen, or the like for displaying information to a computer user. The computer system includes an input interface 160 and one or more input devices, such as a keyboard 161 and a pointing device 162 or touch, voice, or gesture input or the like for interacting with a computer user and providing information to the processor 120. The pointing device 162, for example, may be a mouse, a trackball, touch sensitive device, or a pointing stick for communicating direction information and command selections to the processor 120 and for controlling cursor movement on the display 166. In addition, a printer may provide printed listings of data stored and/or generated by the computer system 110.

The computer system 110 may perform a portion or all of the processing steps of embodiments of the invention in response to the processor 120 executing one or more sequences of one or more instructions contained in a memory, such as the system memory 130. Such instructions may be read into the system memory 130 from another computer readable medium, such as a hard disk 141, SD card, or a removable media drive 142. The hard disk 141 may contain one or more datastores and data files used by embodiments of the Universal Connections Data Collection solution. Datastore contents and data files may be encrypted to improve security. One or more processors in a multi-processing arrangement may also be employed to execute the one or more sequences of instructions contained in system memory 130. In alternative embodiments, hard-wired circuitry may be used in place of or in combination with software instructions. Thus, embodiments are not limited to any specific combination of hardware circuitry and software.

As stated above, the computer system 110 may include at least one computer readable medium or memory for holding instructions programmed according embodiments of the invention and for containing data structures, tables, records, or other data described herein. Non-limiting examples of computer readable media include hard disks, floppy disks, tape, magneto-optical disks, PROMs (EPROM, EEPROM, flash EPROM), DRAM SRAM, SDRAM, or any other magnetic medium, compact discs (e.g., CD-ROM), or any other optical medium, punch cards, paper tape, or other physical medium with patterns of holes, a carrier wave (described below), flash memory, online storage, or any other medium from which a computer can read instructions.

Stored on any one or on a combination of computer readable media, embodiments of the present invention include software for controlling the computer system 110, for driving a device or devices for implementing the invention, and for enabling the computer system 110 to interact with a human user. Such software may include, but is not limited to, device drivers, operating systems, development tools, and applications software. Such computer readable media further comprises a computer program product for performing all or a portion (if processing is distributed) of the processing performed in implementing embodiments of the invention.

Components of the computer system 110 which interpret one or more sequences of instructions may be any interpretable or executable code component including, but not limited to, scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 120 for execution. A computer readable medium may take many forms including, but not limited to, non-volatile media, volatile media, and transmission media. Non-limiting examples of non-volatile media include optical, magnetic disks, and magneto-optical disks, such as hard disk 141 or removable media drive 142. Non-limiting examples of volatile media include dynamic memory, such as system memory 130. Non-limiting examples of transmission media include coaxial cables, copper wire, and fiber optics, including the wires that make up the bus 121. Transmission media may also take the form of acoustic or light waves, such as those generated during radio wave and infrared data communications.

Various forms of computer readable media may be involved in carrying out one or more sequences of one or more instructions to processor 120 for execution. For example, the instructions may initially be carried on a magnetic disk of a remote computer. The remote computer may load the instructions for implementing all or a portion of the present invention remotely into dynamic memory and send the instructions over a telephone line using a modem. A modem local to the computer system 110 may receive the data on the telephone line and use an infrared transmitter to convert the data to an infrared signal. An infrared detector coupled to the bus 121 may receive the data carried in the infrared signal and place the data on the bus 121. The bus 121 carries the data to the system memory 130, from which the processor 120 may retrieve and execute the instructions. The instructions received by the system memory 130 may optionally be stored on storage device 141 or 142 either before or after execution by processor 120.

The computing environment 100 may further include the computer system 120 operating in a networked environment using logical connections to one or more remote computers, such as remote computer 180. Remote computer 180 may be a personal computer, a server, a router, a network PC, a peer device or other common network node, and typically includes many or all of the elements described above relative to computer 110. The logical connections depicted in FIG. 1 include local area network (LAN) 171 and wide area network (WAN) 173, but may also include other networks. These networks can be wired networks, wireless networks, cellular networks, or any other suitable networks. Such networking environments may be common in offices, enterprise-wide computer networks, intranets, and the Internet. Communications may occur via hard wired and/or wireless means.

When used in a LAN networking environment, computer 110 may be connected to LAN 171 through network interface 170. When used in a WAN 173 networking environment, computer 110 may include modem 172 for establishing communications over WAN 173, such as the Internet. Modem 172 may be connected to system bus 121 via user input interface 160, or other appropriate mechanism.

As shown, the computer system 110 may include a communication interface 175 coupled to the bus 121. The communication interface 175 provides a two-way data communication coupling to a network link 171, 173 that is connected to, for example, a local area network (LAN) 171, or to another communications network 173, such as the Internet. For example, the communication interface 175 may be a network interface card to attach to any packet switched LAN. As another example, the communication interface 175 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 175 sends and receives electrical, electromagnetic, or optical signals that carry digital data streams representing various types of information.

Computer 110 or other client device can be deployed as part of a computer network. In this regard, various embodiments pertain to any computer system having any number of memory or storage units, and any number of applications and processes occurring across any number of storage units or volumes. An embodiment may apply to an environment with server computers and client computers deployed in a network environment, having remote or local storage. An embodiment may also apply to a standalone computing device, having programming language functionality, interpretation and execution capabilities.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

What is claimed:

1. A method for aggregating data from computing devices on networks, comprising:
receiving, over a network, first environmental status information pertaining to each of a first subset of a plurality of endpoints located on one or more networks;
storing the first environmental status information in a first group-specific data store assigned to the first subset of endpoints;
sorting the first environmental status information into one or more predetermined first data stores based on the type of environmental status information received;
normalizing the first environmental status information to create first normalized environmental status information; and
storing the first normalized environmental status information in a consolidated datamart.

2. The method of claim 1, further comprising:
receiving second environmental status information pertaining to each of a second subset of the plurality of endpoints; and
storing the second environmental status information in a second group-specific data store assigned to the second subset of endpoints.

3. The method of claim 1, wherein the first environmental status information includes information pertaining to more than one application type or platform type, such that the first environmental status is sorted into multiple first data stores.

4. The method of claim 1, wherein the step of receiving further comprises receiving environmental status information from one or more agents operating on at least a portion of the first subset of a plurality of endpoints.

5. The method of claim 1, wherein the step of receiving comprises receiving environmental status information from one or more agents operating on one or more servers that communicates with at least a portion of the first subset of a plurality of endpoints.

6. The method of claim 1, further comprising:
displaying one or more summaries of the normalized environmental status information.

7. The method of claim 1, wherein the step of sorting further comprises identifying an application running on one or more of the first subset of a plurality of endpoints to which the first environmental status information relates.

8. The method of claim 1, wherein the step of sorting comprises identifying a platform type of one or more of the first subset of a plurality of endpoints to which the first environmental status information relates.

9. The method of claim 1, wherein the step normalizing includes mapping values received to uniform values such that entries in the consolidated datamart can be uniformly displayed regardless of vendor information.

10. The method of claim 1, wherein the step of receiving further comprises receiving environmental status information from endpoints that are not on the same VPN.

11. A system for aggregating data from computing devices on networks, comprising:
a computer configured to receive, over a network, first environmental status information pertaining to a plurality of endpoints located on one or more networks;
a first datamart including a plurality of group-specific data stores, which are assignable to subsets of endpoints;
a first group of application specific staging marts, including storage and logic that normalizes the first environmental status information to create first normalized environmental status information;
logic for sorting the first environmental status information into one or more of the first group of application specific staging marts based on the type of environmental status information received; and
a second datamart containing consolidated environmental status data received from the first group of application specific data marts.

12. The system of claim 11, wherein the computer is further configured to receive first environmental status data includes information pertaining to more than one application type or platform type, such that the first environmental status is sorted into multiple application specific staging marts.

13. The system of claim 11, wherein the computer is configured to receive environmental status information from one or more agents operating on at least a portion of the first subset of a plurality of endpoints.

14. The system of claim 11, wherein the computer is further configured to receive environmental status information from one or more agents operating on one or more servers that communicates with at least a portion of the first subset of a plurality of endpoints.

15. The system of claim 11, further comprising a web interface that allows displaying one or more summaries of the normalized environmental status information.

16. The system of claim 11, further comprising configurable logic that aggregates consolidated environmental status data to enable display of one or more summaries of the data.

17. The system of claim 11, wherein the logic for sorting the first environmental status information identifies an application running on one or more of the first subset of a plurality of endpoints to which the first environmental status information relates.

18. The system of claim 11, wherein the logic for sorting the first environmental status information identifies a platform type of one or more of the first subset of a plurality of endpoints to which the first environmental status information relates.

19. The system of claim 11, wherein the application specific staging marts are configured to map values received to uniform values such that entries in the consolidated datamart can be uniformly displayed regardless of vendor information.

20. The system of claim 11, wherein the computer is configured to receive environmental status information from endpoints that are not on the same VPN.
